(19) United States
(12) Patent Application Publication
(10) Pub. No.: US 2020/0259231 A1
(43) Pub. Date: Aug. 13, 2020

(54) COOLING DEVICE

(71) Applicant: DENSO CORPORATION, Kariya-city (JP)

(72) Inventors: Yasumitsu OMI, Kariya-city (JP); Koji MIURA, Kariya-city (JP); Takeshi YOSHINORI, Kariya-city (JP); Masayuki TAKEUCHI, Kariya-city (JP)

(21) Appl. No.: 16/842,572

(22) Filed: Apr. 7, 2020

Related U.S. Application Data
(63) Continuation of application No. PCT/JP2018/033047, filed on Sep. 6, 2018.

(30) Foreign Application Priority Data
Oct. 17, 2017 (JP) 2017-201185
Apr. 23, 2018 (JP) 2018-082450

(51) Int. Cl. H01M 10/6569; H01M 10/625; H01M 10/6552; H01M 10/613

(52) U.S. Cl. CPC H01M 10/6569; H01M 10/625; H01M 2220/20; H01M 10/613; H01M 10/6552

(57) ABSTRACT

A cooling device for a vehicle is configured as a thermosiphon that performs heat transfer by a working fluid sealed in a sealed container to cool a target object. The cooling device includes an evaporator and an outdoor condenser. The evaporator forms a part of the sealed container, and evaporates the working fluid by absorbing heat of the target device. The outdoor condenser forms a part of the sealed container, and is disposed above the evaporator. The outdoor condenser is located adjacent to a cabin space with respect to a vehicle body around the cabin space. The outdoor condenser is fixed to the vehicle body or a member provided adjacent to the cabin space with respect to the vehicle body, and condenses the working fluid by radiating heat of the working fluid vaporized in the evaporator to an outside air.

### CROSS REFERENCE TO RELATED APPLICATIONS

The present application is a continuation application of International Patent Application No. PCT/JP2018/033047 filed on Sep. 6, 2018, which designated the U.S. and claims the benefit of priority from Japanese Patent Application No. 2017-201185 filed on Oct. 17, 2017 and Japanese Patent Application No. 2018-82450 filed on Apr. 23, 2018. The entire disclosures of all of the above applications are incorporated herein by reference.

### TECHNICAL FIELD

The present disclosure relates to a cooling device that cools a target device.

### BACKGROUND

A cooling device cools a target device such as a secondary battery for a vehicle. The cooling device is configured by a heat pipe utilizing gravity to recirculate a working fluid.

### SUMMARY

According to one aspect of the present disclosure, a cooling device is mounted on a vehicle and configured as a thermosiphon that performs heat transfer by a phase change between a liquid phase and a gas phase of a working fluid sealed in a sealed container, so as to cool a target device by the heat transfer, and including:

an evaporator that forms a part of the sealed container and evaporates the working fluid by absorbing heat of the target device; and

an outdoor condenser that forms a part of the sealed container, the outdoor condenser being disposed above the evaporator, the outdoor condenser being located adjacent to a cabin space with respect to a vehicle body around the cabin space, the outdoor condenser being fixed to the vehicle body or a member provided adjacent to the cabin space with respect to the vehicle body, the outdoor condenser condensing the working fluid by radiating heat of the working fluid vaporized in the evaporator to an outside air.

### BRIEF DESCRIPTION OF DRAWINGS

FIG. 1 is a configuration diagram schematically showing a vehicle in which a cooling device according to a first embodiment is mounted.

FIG. 2 is an enlarged schematic view illustrating a front part of the vehicle in FIG. 1 in which the cooling device of the first embodiment is mounted.

FIG. 3 is an exploded perspective view showing the cooling device and peripheral devices in the first embodiment.

FIG. 4 is a cross-sectional view illustrating the evaporator taken along a plane perpendicular to the axial direction of the evaporator and the outdoor condenser taken along a plane perpendicular to the axial direction of the outdoor condenser in the first embodiment.

FIG. 5 is a view illustrating the outdoor condenser and a condensation heat diffusion plate as seen in an arrow direction V in FIG. 3.

FIG. 6 is a longitudinal sectional view illustrating an indoor condenser taken along a plane including the central axis in the first embodiment.

FIG. 7 is an exploded perspective view showing an outdoor condenser and the vicinity of a cooling device according to a second embodiment, viewed in the same direction as FIG. 3.

FIG. 8 is an exploded perspective view showing an outdoor condenser and the vicinity of a cooling device according to a third embodiment, viewed in the same direction as FIG. 3.

FIG. 9 is an enlarged schematic view illustrating a front part of the vehicle in which a cooling device according to a fourth embodiment is mounted, as corresponding to FIG. 2.

FIG. 10 is a cross-sectional view taken along a line X-X of FIG. 9.

FIG. 11 is an enlarged schematic view illustrating a front part of the vehicle in which a cooling device according to a fifth embodiment is mounted, as corresponding to FIG. 9.

FIG. 12 is an enlarged schematic view illustrating a front part of the vehicle in which a cooling device according to a sixth embodiment is mounted, as corresponding to FIG. 9.

FIG. 13 is an enlarged schematic view illustrating a second evaporator and the periphery of a cooling device according to a seventh embodiment, as similarly to FIG. 2.

FIG. 14 is a perspective view illustrating a cooling device and a peripheral portion thereof according to an eighth embodiment, as corresponding to FIG. 3.

FIG. 15 is a perspective view illustrating a cooling device and a peripheral portion thereof according to a ninth embodiment, as corresponding to FIG. 14.

FIG. 16 is a perspective view illustrating a cooling device and a peripheral portion thereof according to a tenth embodiment, as corresponding to FIG. 15.

FIG. 17 is a perspective view illustrating a cooling device and a peripheral portion thereof according to an eleventh embodiment, as corresponding to FIG. 3.

FIG. 18 is a cross-sectional view taken along a line XVIII-XVIII of FIG. 17.

FIG. 19 is a perspective view illustrating a cooling device and a peripheral portion thereof according to a twelfth embodiment, as corresponding to FIG. 17.

FIG. 20 is a perspective view illustrating a cooling device and a peripheral portion thereof according to a thirteenth embodiment, as corresponding to FIG. 14.

FIG. 21 is a perspective view illustrating a cooling device and a peripheral portion thereof according to a fourteenth embodiment, as corresponding to FIG. 20.

FIG. 22 is a schematic diagram illustrating an evaporator, a heating device, and a periphery thereof of a cooling device according to a fifteenth embodiment, as similarly to FIG. 2.

FIG. 23 is an exploded perspective view illustrating an outdoor condenser and its vicinity of a cooling device according to a sixteenth embodiment, as corresponding to FIG. 7.

FIG. 24 is a diagram solely illustrating a resin clip used to fix a condensation heat diffusion plate to a body panel in a seventeenth embodiment.

FIG. 25 is an exploded perspective view illustrating a cooling device and peripheral devices in an eighteenth embodiment, as corresponding to FIG. 3.

FIG. 26 is a diagram solely illustrating a pipe fixing clip used to fix an outdoor condenser to a body panel in the eighteenth embodiment.

FIG. 27 is an enlarged schematic diagram illustrating a front part of the vehicle shown in FIG. 1 on which a cooling device according to a nineteenth embodiment is mounted, as corresponding to FIG. 2.

FIG. 28 is an enlarged schematic diagram illustrating a front part of the vehicle shown in FIG. 1 on which a cooling device according to a twentieth embodiment is mounted, as corresponding to FIG. 2.

FIG. 29 is an enlarged schematic diagram illustrating a front part of the vehicle shown in FIG. 1 on which a cooling device according to a twenty-first embodiment is mounted, as corresponding to FIG. 2.

FIG. 30 is an enlarged schematic diagram illustrating a front part of the vehicle shown in FIG. 1 on which a cooling device according to a twenty-second embodiment is mounted, as corresponding to FIG. 2.

FIG. 31 is a schematic diagram illustrating a cooling device and peripheral devices according to a twenty-third embodiment, as similarly to FIG. 2.

FIG. 32 is an exploded perspective view illustrating a cooling device and peripheral devices according to the twenty-third embodiment, as corresponding to FIG. 3.

FIG. 33 is a schematic diagram illustrating a cooling device and peripheral devices according to a twenty-fourth embodiment, similarly to FIG. 2, as corresponding to FIG. 31.

FIG. 34 is an enlarged schematic view illustrating a front part of a vehicle in which a cooling device according to another embodiment is mounted, as corresponding to FIG. 2.

FIG. 35 is a view illustrating a spiral tube which is an example of a tubular member in another embodiment.

### DETAILED DESCRIPTION

To begin with, examples of relevant techniques will be described.

A cooling device cools a secondary battery for a vehicle. The cooling device is configured by a heat pipe utilizing gravity to recirculate a liquid-phase working fluid. Since the entire cooling device is installed in the cabin space, the heat of the secondary battery is dissipated to the inside air.

Since the cooling device is configured by a heat pipe, it is easy to uniformly cool the target device by suppressing temperature unevenness in the target device. Further, since heat can be radiated collectively by the heat radiating portion (in other words, the condenser) in the heat pipe, it is possible to downsize the blower that blows air toward the heat radiating portion. In this case, the noise generated by the blower can be reduced.

However, since the cooling device radiates heat to the inside air, there is a possibility that the occupant may feel uncomfortable. In order to restrict the occupant from feeling uncomfortable, it is effective to radiate heat to outside air. Therefore, when outside air can be used for cooling the target device, it is preferable to use outside air.

For these reasons, the inventors have considered using outside air to cool the target device using a thermosiphon, which is a type of heat pipe. According to detailed studies by the inventors, it can be found as follows.

The present disclosure provides a cooling device that can cool a target device by radiating heat to the outside air, with a simple structure in which the target device is arranged adjacent to the cabin space with respect to a vehicle body.

According to one aspect of the present disclosure, a cooling device that is mounted on a vehicle and configured as a thermosiphon that performs heat transfer by a phase change between a liquid phase and a gas phase of a working fluid sealed in a sealed container, so as to cool a target device by the heat transfer, the cooling device including:

an evaporator that forms a part of the sealed container and evaporates the working fluid by absorbing heat of the target device; and

an outdoor condenser that forms a part of the sealed container, the outdoor condenser being disposed above the evaporator, the outdoor condenser being located adjacent to a cabin space with respect to a vehicle body around the cabin space, the outdoor condenser being fixed to the vehicle body or a member provided adjacent to the cabin space with respect to the vehicle body, the outdoor condenser condensing the working fluid by radiating heat of the working fluid vaporized in the evaporator to an outside air.

Accordingly, it is possible to cool the target device by radiating heat to the outside air via the outdoor condenser, with a simple structure in which the target device is arranged adjacent to the cabin space with respect to a vehicle body.

Hereinafter, embodiments will be described with reference to the drawings. In the following embodiments, the same reference numeral is given to the same or equivalent parts in the drawings.

### First Embodiment

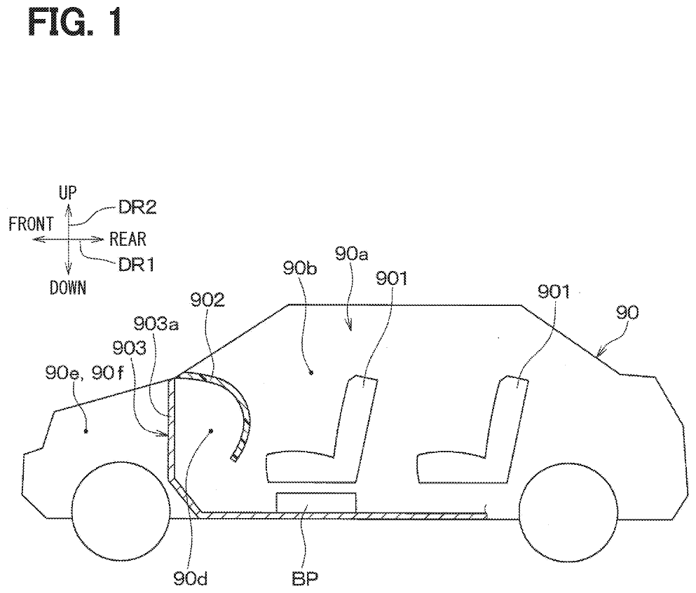

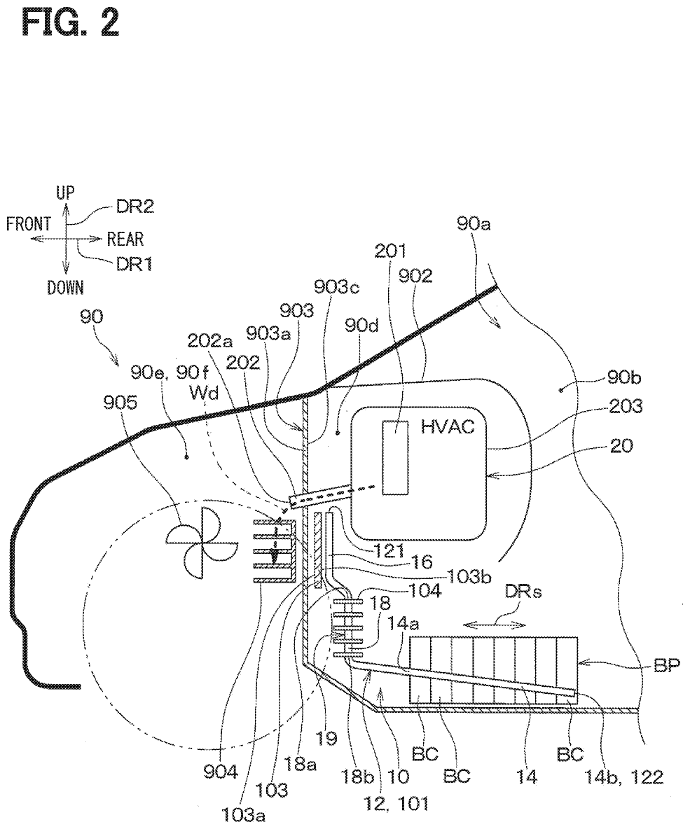

As shown in FIGS. 1 and 2, a vehicle 90 of the present embodiment is equipped with a battery pack BP. A cooling device 10 of the present embodiment is mounted on the vehicle 90 and cools the battery pack BP. A target device to be cooled by the cooling device 10 is the battery pack BP. In the present embodiment, the vehicle 90 is an electric vehicle or a hybrid vehicle that can be driven by a driving electric motor, which is not shown, that uses the battery pack BP as a power source.

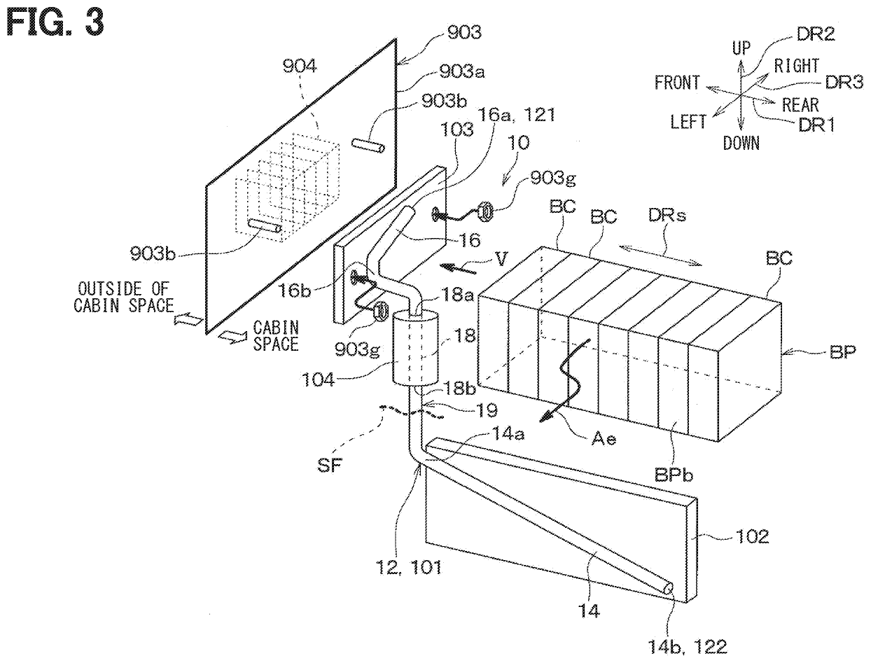

Each of arrows DR1, DR2, DR3 of FIG. 1 and FIG. 3 shows the direction of the vehicle 90 in which the cooling device 10 is mounted. The arrow DR1 in FIG. 1 represents a front-rear direction DR1 of the vehicle, and the arrow DR2 represents an up-down direction DR2 of the vehicle. In FIG. 3, the arrow DR3 represents a left-right direction DR3 of the vehicle, i.e. a width direction DR3 of the vehicle. The directions DR1, DR2, DR3 intersect with each other. Specifically, the directions DR1, DR2, DR3 are orthogonal to each other. Each of the front-rear direction DR1 and the width direction DR3 is one direction included in the horizontal direction of the vehicle 90 (in other words, the lateral direction of the vehicle 90).

As shown in FIGS. 2 and 3, the battery pack BP has plural battery cells BC having a rectangular parallelepiped shape. The battery pack BP is configured by a stacked body in which the battery cells BC are stacked. Specifically, the battery cells BC are stacked in a predetermined stacking direction DRs. Therefore, the entire battery pack BP also has a substantially rectangular parallelepiped shape.

The battery pack BP has a battery side surface BPb that extends in the up-down direction DR2 as a part of the surface of the battery pack BP. The stacking direction DRs of the battery cells BC, that is, the cell stacking direction DRs may be any direction, but in the present embodiment, coincides with the front-rear direction DR1.

The battery cells BC of the battery pack BP are electrically connected in series. Each of the battery cells BC of battery pack BP is configured by a chargeable and dischargeable secondary battery (for example, a lithium ion battery or a lead storage battery). The battery cell BC is not limited to the rectangular parallelepiped shape, and may have another shape such as a cylindrical shape. The battery pack BP may be configured to include battery cells BC electrically connected in parallel.

When the battery pack BP supplies power or the like while the vehicle 90 is running, the battery pack BP generates heat. When the battery pack BP is left in a high-temperature environment, the battery pack BP deteriorates. Therefore, it is necessary to cool the battery pack BP by the cooling device 10.

The cooling device 10 includes a hermetically sealed container 101, an evaporation heat diffusion plate 102, a condensation heat diffusion plate 103, and an indoor fin 104. The cooling device 10 is configured as a thermosiphon that performs heat transfer by a phase change between a liquid phase and a gas phase of the working fluid sealed in the sealed container 101. The cooling device 10 cools the battery pack BP by heat transfer in the thermosiphon.

The thermosiphon is a kind of heat pipe, and is a device for returning a working fluid in a liquid phase condensed in condensers 16 and 18 of the sealed container 101 to an evaporator 14 of the sealed container 101 by using gravity. The sealed container 101, the evaporation heat diffusion plate 102, the condensation heat diffusion plate 103, and the indoor fin 104 are made of a material having high thermal conductivity (for example, a metal material such as an aluminum alloy).

As shown in FIGS. 1 and 2, the entirety of the sealed container 101, the evaporation heat diffusion plate 102, the condensation heat diffusion plate 103, the indoor fins 104, and the battery pack BP are arranged in a cabin space 90a. The cabin space 90a is a space provided in the cabin, and is constructed of a seat space 90b in which an occupant seat 901 is provided, and a communication space 90d connected to the seat space 90b so that air flows therethrough. The cabin space 90a does not include a non-communication space 90e in which the flow of air to the seat space 90b is blocked. The communication space 90d includes, for example, a space inside the instrument panel 902, a luggage room, a space inside the center console, and a space behind a carpet laid under a feet of the occupant. The non-communication space 90e includes, for example, an engine room 90f and an outside of the vehicle. Since the engine room 90f and the outside of the vehicle are not spaces provided in the cabin, the engine room 90f and the outside of the vehicle are not included in the cabin space 90a.

As shown in FIGS. 2 and 3, the sealed container 101 is formed of a tubular member 12. In the present embodiment, the number of the tubular members 12 that forms the sealed container 101 is one. The tubular member 12 is made of, for example, a seamless tube. The tubular member 12 is formed by bending a straight pipe at a plurality of locations. The tubular member 12 has a tube end 121 and a tube end 122 at one end and the other end of the tubular member 12, respectively.

Each of the tube ends 121, 122 is hermetically closed by brazing or a sealing plug. Thereby, the sealed container 101 is in a tightly sealed state.

A working fluid is poured in the sealed container 101, and the sealed container 101 is filled with the working fluid. The working fluid is, for example, a refrigerant such as R134a and R1234yf used in a vapor compression refrigeration cycle.

Specifically, the working fluid is filled in the sealed container 101 at a predetermined filling amount. The predetermined filling amount is set such that a liquid level SF of the liquid-phase working fluid is above the evaporator 14 and below the indoor condenser 18 when the thermosiphon is not operating in a state where the cooling device 10 is mounted on the vehicle. The non-operation of the thermosiphon means a state in which the working fluid is not evaporated and is not condensed in the sealed container 101. On the other hand, the operation of the thermosiphon means a state in which the working fluid is being evaporated and condensed in the sealed container 101.

Focusing on the functional aspect of the sealed container 101, the sealed container 101 includes the evaporator 14, the outdoor condenser 16, and the indoor condenser 18. The evaporator 14, the outdoor condenser 16 and the indoor condenser 18 are each configured as a part of the tubular member 12.

The evaporator 14, the indoor condenser 18, and the outdoor condenser 16 are connected in this order in series. At the same time, the evaporator 14, the indoor condenser 18 and the outdoor condenser 16 are arranged in this order from the lower side of the vehicle 90. Therefore, the lower end 16b of the outdoor condenser 16 is connected to the upper end 18a of the indoor condenser 18, and the upper end 14a of the evaporator 14 is connected to the lower end 18b of the indoor condenser 18.

The evaporator 14 evaporates the working fluid by absorbing heat from the battery pack BP into the working fluid in the evaporator 14. For this purpose, as shown in FIG. 3, the evaporator 14 is joined to the evaporation heat diffusion plate 102 having a flat plate shape, for example, by brazing. For the connection between the evaporator 14 and the evaporation heat diffusion plate 102, a method other than brazing may be adopted while good thermal conductivity between the connection between the evaporator 14 and the evaporation heat diffusion plate 102 can be obtained.

The other side of the evaporation heat diffusion plate 102 opposite to the one surface to which the evaporator 14 is joined is connected to the battery side surface BPb so as to be able to conduct heat. In other words, the battery pack BP is connected to the evaporation heat diffusion plate 102 so as to conduct heat as indicated by an arrow Ae with the battery side surface BPb facing the evaporation heat diffusion plate 102. The evaporator 14 is fixed to the battery pack BP via the evaporation heat diffusion plate 102 in a state where heat can be conducted to the battery pack BP. The evaporation heat diffusion plate 102 is held in a state of being pressed against the battery pack BP so that the thermal conductivity between the evaporation heat diffusion plate 102 and the battery pack BP is maintained well. Further, the evaporation heat diffusion plate 102 and the battery pack BP may be in direct contact with each other, but, for example, a heat conductive sheet material or grease is interposed between the evaporation heat diffusion plate 102 and the battery pack BP to increase thermal conductivity.

As shown in FIG. 3, the evaporator 14 is disposed to be inclined with respect to the horizontal direction of the vehicle 90 at an angle closer to the horizontal direction of the vehicle 90 than the up-down direction DR2. Specifically, the evaporator 14 extends to be slightly inclined with respect to the horizontal direction of the vehicle 90 such that the upper end 14a of the evaporator 14 is located above the tube end 122 that is the lower end 14b of the evaporator 14. In other words, the evaporator 14 extends to be slightly inclined with respect to the horizontal direction of the vehicle 90 so that the evaporator 14 is located higher as approaching to the upper end 14a from the lower end 14b.

Thus, the gas-phase working fluid evaporated in the evaporator 14 flows not to the lower end 14b but to the upper end 14a of the evaporator 14, and further flows from the upper end 14a to the condensers 16 and 18. That is, the gas-phase working fluid that has become bubbles in the evaporator 14 easily flows out of the evaporator 14 to the condensers 16 and 18, and the liquid-phase working fluid easily returns from the condensers 16 and 18 to the evaporator 14.

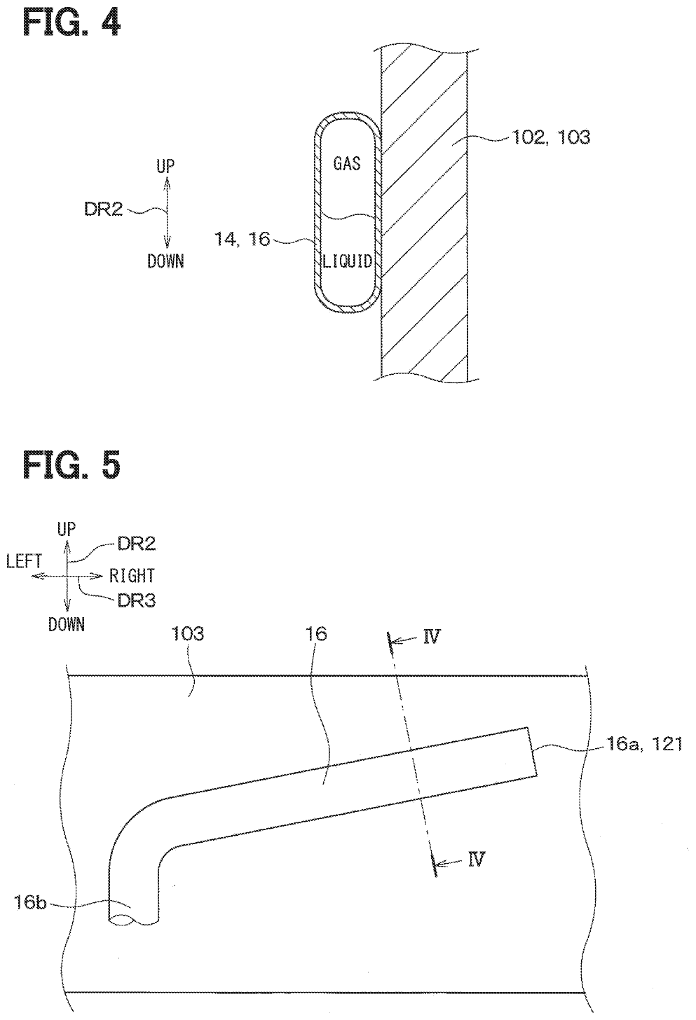

The evaporator 14 is a part of the tubular member 12 and thus has a tubular shape. However, as shown in detail in FIG. 4, the evaporator 14 has a flat cross-sectional shape extending in the up-down direction DR2. One flat surface in the flat cross-section of the evaporator 14 is joined to the evaporation heat diffusion plate 102.

As shown in FIGS. 1 and 2, the vehicle 90 has a vehicle body 903 that surrounds the cabin space 90a. The outdoor condenser 16 of the sealed container 101 is disposed adjacent to the cabin space 90a with respect to the vehicle body 903 around the cabin space 90a. More specifically, the outdoor condenser 16 is disposed within the cabin space 90a. The outdoor condenser 16 is fixed to the vehicle body 903 so that the outdoor condenser 16 can be removed from the vehicle body 903. Since the outdoor condenser 16 is disposed adjacent to the cabin space 90a with respect to the vehicle body 903, the outdoor condenser 16 can be removed from the vehicle body 903 to the cabin space 90a.

In the present embodiment, the outdoor condenser 16 is fixed on the vehicle body 903 at a fixing portion of the vehicle body 903, and the fixing portion is a body panel 903a as a body component that forms a part of the vehicle body 903 around the cabin space 90a. The body panel 903a is formed of a plate-like member having a vertical wall shape that separates the engine room 90f and the cabin space 90a from each other.

The outdoor condenser 16 can be removed from the vehicle body 903 since the outdoor condenser 16 is fixed to from the vehicle body 903 using a detachable structure such as a bolt, a nut, a clip, or a snap fit. In the present embodiment, the outdoor condenser 16 is fixed to the vehicle body 903 by a nut as described later.

As shown in FIGS. 2 and 3, the outdoor condenser 16 condenses the working fluid by radiating heat from the working fluid vaporized by the evaporator 14 to the outside air. The outdoor condenser 16 radiates heat from the working fluid in the outdoor condenser 16 to the outside air via the vehicle body 903. For this purpose, the outdoor condenser 16 is joined to the condensation heat diffusion plate 103 by, for example, brazing. For the connection between the outdoor condenser 16 and the condensation heat diffusion plate 103, a method other than brazing may be adopted while good thermal conductivity between the outdoor condenser 16 and the condensation heat diffusion plate 103 can be obtained. The outside air is air outside the vehicle or air in the non-communication space 90e such as the engine room 90f outside the cabin space 90a. In short, the outside air is air outside the cabin space 90a.

The condensation heat diffusion plate 103 has one surface 103a facing the body panel 903a of the vehicle body 903, and the other surface 103b opposite the one surface 103a to which the outdoor condenser 16 is joined. The condensation heat diffusion plate 103 is connected to the body panel 903a at the one surface 103a so as to be able to conduct heat. The condensation heat diffusion plate 103 is fixed in a state of being pressed against the body panel 903a by a nut structure. The condensation heat diffusion plate 103 is fixed to the body panel 903a by fastening a nut 903g to a bolt 903b protruding from the body panel 903a toward the cabin space 90a. In other words, the nut 903g is screwed to the bolt 903b fixed to the body panel 903a from a side of the cabin space 90a with respect to the body panel 903a.

In this manner, the outdoor condenser 16 is fixed to an indoor body surface 903c, which is a surface of the vehicle body 903 adjacent to the cabin space 90a, to be able to conduct heat to the vehicle body 903 via the condensation heat diffusion plate 103. This allows the outdoor condenser 16 to transfer heat to the outside air in the engine room 90f. In short, the outdoor condenser 16 is a heat exchanger that is fixed to the vehicle body 903 to conduct heat to the outside air.

The condensation heat diffusion plate 103 and the body panel 903a may be in direct contact with each other. For example, a heat conductive sheet material or grease is interposed between the condensation heat diffusion plate 103 and the body panel 903a to increase the thermal conductivity.

The vehicle 90 includes an outdoor condensing fin 904 for facilitating heat radiation from the working fluid in the outdoor condenser 16 to the outside air, and an outdoor blower 905. The outdoor condensing fin 904 is made of a material having high thermal conductivity (for example, a metal material such as an aluminum alloy).

The outdoor condensing fin 904 is provided outside the cabin space 90a so as to be exposed to the outside air, and is fixed to be able to conduct heat to the body panel 903a of the vehicle body 903. For example, the outdoor condensing fin 904 is joined to the body panel 903a by welding or bolting. The outdoor condensing fin 904 is disposed on the opposite side of the condensation heat diffusion plate 103 with the body panel 903a interposed therebetween.

For example, the outdoor condensing fin 904 is arranged at a place in the engine room 90f where outside air flows when the vehicle travels around the outdoor condensing fin 904. The outdoor blower 905 in FIG. 2 blows outside air to the outdoor condensing fin 904, and is disposed, for example, in the engine room 90f. Therefore, even when the vehicle is stopped, for example, when the outside air does not flow to the outdoor condensing fin 904, the outside air can be blown to the outdoor condensing fin 904 by the outdoor blower 905.

In FIG. 2, components such as the outdoor condenser 16, the condensation heat diffusion plate 103, the body panel 903a, and the outdoor condensing fin 904 are illustrated with a slight gap, for easy-to-understand illustration. In actuality, there might be no such a gap. The illustration of the evaporation heat diffusion plate 102 is omitted. These are the same in the following drawings corresponding to FIG. 2 similarly.

As shown in FIG. 5, the outdoor condenser 16 is arranged in the same posture as the evaporator 14. That is, the outdoor condenser 16 is disposed to be inclined with respect to the horizontal direction of the vehicle 90 at an angle closer to the horizontal direction of the vehicle 90 than the up-down direction DR2. Specifically, the outdoor condenser 16 extends to be slightly inclined with respect to the horizontal direction of the vehicle 90 so that the lower end 16b of the outdoor condenser 16 is located below the tube end 121 that is the upper end 16a of the outdoor condenser 16. In other words, the outdoor condenser 16 extends to be slightly inclined with respect to the horizontal direction of the vehicle 90 so that the outdoor condenser 16 is located lower as approaching the lower end 16b from the upper end 16a.

The liquid-phase working fluid condensed in the outdoor condenser 16 flows to the lower end 16b of the outdoor condenser 16, not to the upper end 16a, due to the action of gravity, and flows to the evaporator 14 from the lower end 16b. That is, the gas-phase working fluid such as bubbles in the outdoor condenser 16 easily moves toward the upper end 16a, and the liquid-phase working fluid in the outdoor condenser 16 easily flows from the lower end 16b of the outdoor condenser 16 to the evaporator 14.

The outdoor condenser 16 has a tubular shape similarly to the evaporator 14. That is, as shown in FIG. 4, the outdoor condenser 16 has a flat cross-sectional shape extending in the up-down direction DR2. One flat surface of the outdoor condenser 16 in the flat cross-section is joined to the condensation heat diffusion plate 103. FIG. 4 is a cross-sectional view of the evaporator 14 and also a cross-sectional view of the outdoor condenser 16 taken along a line IV-IV of FIG. 5.

As shown in FIG. 2, the vehicle 90 of the present embodiment includes an air conditioning unit 20 that performs air conditioning in the seat space 90b. The air conditioning unit 20 is arranged inside the instrument panel 902. The air conditioning unit 20 has an evaporator 201 for cooling air for air conditioning, and a drain section 202 for discharging drain water Wd generated by condensation on the surface of the evaporator 201.

The drain section 202 is formed of a pipe led out of the air conditioning case 203 of the air conditioning unit 20 to the outside of the cabin space 90a (specifically, to the engine room 90f). The discharge port 202a of the drain section 202 is arranged in a common space with the outdoor condensing fin 904, that is, in the engine room 90f, and is located above the outdoor condensing fin 904.

Therefore, when the drain water Wd flows out from the discharge port 202a of the drain section 202 as shown by the dashed arrow, the drain water Wd falls on the outdoor condensing fin 904. In that case, the outdoor condensing fin 904 performs heat exchange not only with the outside air around the outdoor condensing fin 904 but also with the drain water Wd. That is, the outdoor condenser 16 is configured to be able to radiate heat from the working fluid to the drain water Wd, which is a heat radiation object different from the outside air, via the outdoor condensing fin 904.

As shown in FIGS. 2 and 3, the indoor condenser 18 of the sealed container 101 is disposed in the cabin space 90a and radiates heat of the working fluid vaporized by the evaporator 14 to the inside air to condense the working fluid. Therefore, the indoor condenser 18 corresponds to another condenser that condenses the working fluid by releasing heat from the working fluid to a predetermined heat radiation object other than the outside air. In the case of the indoor condenser 18, the predetermined heat radiation object is the inside air. The inside air is air in the cabin space 90a.

An indoor fin 104 is joined to the outer peripheral surface of the indoor condenser 18 over the entire circumference. The indoor fin 104 is, for example, spine fin, and facilitates heat radiation from the working fluid in the indoor condenser 18 to the inside air.

The indoor condenser 18 is included in an upper and lower pipe 19 configured as a part of the tubular member 12. The upper and lower pipe 19 is a pipe portion arranged to extend in the up-down direction DR2.

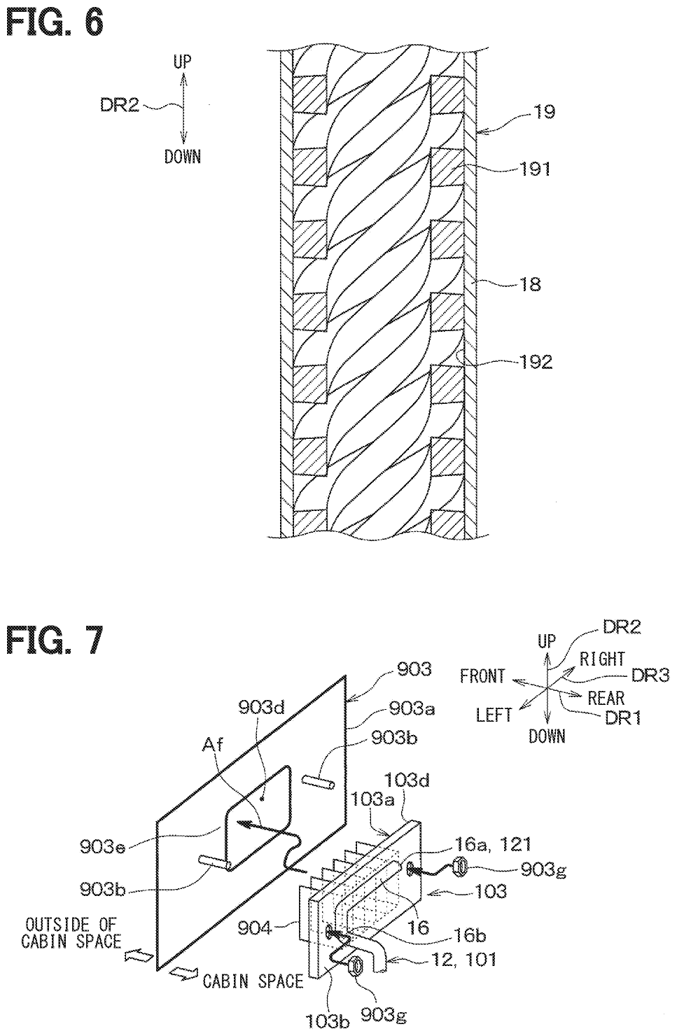

As shown in FIG. 6, the upper and lower pipe 19 has a guide 191 formed in a spiral shape, and the guide 191 is located in the upper and lower pipe 19. The guide 191 guides a liquid-phase working fluid flowing down in the upper and lower pipe 19. Specifically, the guide 191 is formed of a spiral internal fin that protrudes radially inward from the inner wall 192 of the upper and lower pipe 19. The guide 191 guides the liquid-phase working fluid such that the liquid-phase working fluid coming into contact with the inner wall 192 of the upper and lower pipe 19 flows down while swirling along the inner wall 192.

The guide 191 is provided over the entire length or substantially the entire length of the upper and lower pipe 19 in the longitudinal direction of the upper and lower pipe 19. Therefore, the guide 191 extends to the indoor condenser 18 and is provided over the entire length of the indoor condenser 18. The guide 191 of the present embodiment is a component separate from the tubular member 12, and is made of a material having high thermal conductivity such as an aluminum alloy.

Next, an operation when the cooling device 10 cools the battery pack BP will be described. As shown in FIGS. 2 and 3, when the evaporator 14 of the cooling device 10 receives heat from the battery pack BP, the liquid-phase working fluid in the evaporator 14 evaporates due to the heat of the battery pack BP. Thereby, the battery pack BP is cooled. The gas-phase working fluid evaporated in the evaporator 14 rises in the sealed container 101 and reaches the indoor condenser 18.

A part of the gas-phase working fluid that has reached the indoor condenser 18 releases heat to the inside air and condenses, and the condensed liquid-phase working fluid flows down to the evaporator 14 by the action of gravity. On the other hand, the working fluid remaining as a gas phase without being condensed in the indoor condenser 18 further rises in the sealed container 101 and reaches the outdoor condenser 16.

The gas-phase working fluid that has reached the outdoor condenser 16 releases heat to the outside air and condenses, and the condensed liquid-phase working fluid flows down to the evaporator 14 through the indoor condenser 18 by the action of gravity. As described above, the phase change between the liquid phase and the gas phase of the working fluid is repeated in the sealed container 101, whereby the battery pack BP is cooled.

According to the present embodiment, as shown in FIGS. 2 and 3, the outdoor condenser 16 of the cooling device 10 is disposed adjacent to the cabin space 90a with respect to the vehicle body 903. The outdoor condenser 16 is fixed to the vehicle body 903, and condenses the working fluid by radiating heat of the working fluid vaporized by the evaporator 14 to the outside air. Therefore, the battery pack BP is disposed adjacent to the cabin space 90a (for example, in the cabin space 90a) with respect to the vehicle body 903 with a simple structure, while allowing the battery pack BP to be cooled by heat radiation to the outside air via the outdoor condenser 16.

The outdoor condenser 16 is capable of transferring heat to the outside air by being fixed to the vehicle body 903. That is, it is possible to radiate heat from the outdoor condenser 16 to the outside air without having to take in outside air from the outside of the cabin space 90a separated by the vehicle body 903 to the cabin space 90a. Therefore, the battery pack BP is disposed adjacent to the cabin space 90a (for example, in the cabin space 90a) with respect to the vehicle body 903, with a simpler structure, while allowing the battery pack BP to be cooled by heat radiation to the outside air via the outdoor condenser 16. For example, it is possible to restrict the structure of the cooling device 10 from becoming complicated due to a waterproof structure or the like that is required as a result of providing a configuration for taking in outside air into the cabin space 90a.

Further, when the battery pack BP is disposed adjacent to the cabin space 90a with respect to the vehicle body 903 as in the present embodiment, both the evaporator 14 and the outdoor condenser 16 are arranged adjacent to the cabin space 90a, that is, on the same side of the vehicle body 903 as the battery pack BP. This also allows the cooling device 10 to have a simple structure.

Further, according to the present embodiment, the outdoor condenser 16 radiates heat from the working fluid in the outdoor condenser 16 to the outside air via the vehicle body 903. The outdoor condenser 16 is fixed to the indoor body surface 903c of the vehicle body 903 so as to be able to conduct heat to the vehicle body 903, whereby the outdoor condenser 16 can conduct heat to outside air. Therefore, it is possible to utilize the vehicle body 903 as a part of the heat transfer path, and to arrange the outdoor condenser 16 on the side of the cabin space 90a with respect to the vehicle body 903 with a simple assembly structure.

Further, since it is not necessary to make a hole in the vehicle body 903 so that the outdoor condenser 16 can conduct heat to outside air, there is no need to worry about water intrusion and/or complicated structures such as a seal structure.

Further, according to the present embodiment, the vehicle 90 includes the outdoor condensing fin 904 for facilitating heat radiation from the working fluid in the outdoor condenser 16 to the outside air. The outdoor condensing fin 904 is provided outside the cabin space 90a so as to be exposed to the outside air, and is fixed so as to be able to conduct heat to the vehicle body 903. Therefore, it is possible to improve the condensing ability for condensing the working fluid in the outdoor condenser 16.

Further, according to the present embodiment, the cooling device 10 includes the condensation heat diffusion plate 103 to which the outdoor condenser 16 is joined. The outdoor condenser 16 is fixed to the indoor body surface 903c of the vehicle body 903 via the condensation heat diffusion plate 103. Therefore, the heat transfer area that contributes to the heat transfer between the outdoor condenser 16 and the vehicle body 903 can be easily increased. The shape of the outdoor condenser 16 may be a simple shape such as a simple tube shape as in the present embodiment, while keeping the heat transfer performance between the outdoor condenser 16 and the vehicle body 903. Further, the outdoor condenser 16 can be attached to the vehicle body 903 with a simple structure like a nut stopper of the present embodiment.

Further, according to the present embodiment, the evaporator 14 and the battery pack BP are arranged in the cabin space 90a. The outdoor condenser 16 is fixed to the vehicle body 903 so as to be detachable from the vehicle body 903. Therefore, it is possible to easily configure the cooling device 10 so that the sealed container 101 including the outdoor condenser 16 and the evaporator 14 can be attached to and detached from the vehicle body 903 from a side adjacent to the cabin space 90a.

For example, in a state where the evaporator 14 is fixed to the battery pack BP in advance, the sealed container 101 is installed together with the battery pack BP in the cabin space 90a, and the outdoor condenser 16 is mounted on the vehicle body 903 from a side adjacent to the cabin space 90a. Alternatively, it is also possible to assemble the evaporator 14 with respect to the battery pack BP in the cabin space 90a and, at the same time, assemble the outdoor condenser 16 with the vehicle body 903 from a side adjacent to the cabin space 90a.

Therefore, the sealed container 101 can be assembled to the vehicle body 903 in a state where the sealed container 101 is filled with the working fluid. Therefore, it is possible to reduce steps such as evacuation and filling of the working fluid in the process of assembling the cooling device 10 to the vehicle. Accordingly, it is possible to improve the flexibility of the work sequence in the process of assembling the cooling device 10 to the vehicle. Further, it is easy to configure the sealed container 101 filled with the working fluid so as to be attached to and detached from the vehicle body 903 or the battery pack BP. In this case, the work of releasing and refilling the working fluid can be reduced, for example, at the time of repair or inspection. This has an advantage that the structure of the sealed container 101 can be simplified even if the sealed container 101 is not formed of the tubular member 12.

Further, according to the present embodiment, the outdoor condenser 16 is configured to be able to release heat from the working fluid not only to the outside air but also to the drain water Wd of the air conditioning unit 20. Therefore, even when it is difficult to radiate heat from the outdoor condenser 16 to the outside air due to, for example, a high-temperature outside air, the heat radiation from the outdoor condenser 16 can be facilitated by the drain water Wd. As a result, it is possible to improve the condensation efficiency and the condensation capacity of the working fluid in the cooling device 10. In addition, the condensation capability of the outdoor condenser 16 can be controlled by switching the heat release to the drain water Wd.

Further, assuming that an indoor blower for cooling the indoor condenser 18 by sending air is provided, the indoor blower can be simplified or downsized as compared with a case where heat is emitted from the outdoor condenser 16 to only the outside air. Such simplification or downsizing of the indoor blower leads to reduce noise of the indoor blower, and it is possible to reduce the influence of battery waste heat from the battery pack BP into the cabin space 90a.

Further, according to the present embodiment, the indoor condenser 18 forms a part of the sealed container 101, and is disposed above the evaporator 14 to condense the working fluid by releasing heat from the working fluid to the inside air. Therefore, even when heat cannot be released from the outdoor condenser 16 to the outside air due to a high-temperature outside air, the operation of the thermosiphon can be maintained. As a result, it is possible to improve the condensation efficiency and the condensation capacity of the working fluid in the cooling device 10.

Further, according to the present embodiment, the sealed container 101 is formed of the tubular member 12. The evaporator 14, the indoor condenser 18, and the outdoor condenser 16 are each configured as a part of the tubular member 12. Therefore, it is possible to establish a thermosiphon with a simple structure of the tubular member 12.

Further, according to the present embodiment, the evaporator 14, the indoor condenser 18, and the outdoor condenser 16 are each configured as a part of the tubular member 12, and the evaporator 14, the indoor condenser 18, and the outdoor condenser 16 are arranged in this order from the lower side. The lower end 16b of the outdoor condenser 16 is connected to the upper end 18a of the indoor condenser 18, and the upper end 14a of the evaporator 14 is connected to the lower end 18b of the indoor condenser 18. Therefore, as in the present embodiment, the evaporator 14, the indoor condenser 18, and the outdoor condenser 16 are connected in series in the order of the evaporator 14, the indoor condenser 18, and the outdoor condenser 16 to form one tubular member 12. From this arrangement order, the gas-phase working fluid evaporated in the evaporator 14 reaches the indoor condenser 18 before reaching the outdoor condenser 16. Therefore, the working fluid can be efficiently condensed in the indoor condenser 18 by restricting heat damage by outside air in which the working fluid is evaporated by the heat of the outside air when the outside air is at a high temperature.

For example, when the outside air temperature is low, the working fluid evaporated by the heat of the battery pack BP is condensed by radiating heat to the outside air. On the other hand, when the outside air temperature is high, such as in summer, the working fluid evaporated by the heat of the battery pack BP is condensed by radiating heat to the inside air cooled by an air conditioner.

Further, according to the present embodiment, the upper and lower pipe 19 is configured as a part of the tubular member 12, and is arranged to extend in the up-down direction DR2. Then, as shown in FIG. 6, the upper and lower pipe 19 has the spiral guide 191 for guiding the liquid-phase working fluid such that the liquid-phase working fluid coming into contact with the inner wall 192 of the upper and lower pipe 19 flows down while swirling and rotating along the inner wall 192. That is, the guide 191 functions as a swirl generator that imparts a swirl speed component to the liquid-phase working fluid flowing down in the upper and lower pipe 19.

Therefore, the working fluid in the liquid phase descends in an annular flow along the guide 191 in the upper and lower pipe 19. At the same time, the gas-phase working fluid rises inside the annular flow (for example, at the pipe center and its vicinity of the upper and lower pipe 19). Thereby, the gas-liquid separation of the working fluid is improved in the upper and lower pipe 19, so that the cooling performance of the cooling device 10 can be improved.

According to the present embodiment, as shown in FIGS. 3 and 6, the upper and lower pipe 19 includes the indoor condenser 18. The guide 191 of the upper and lower pipe 19 is formed of an internal fin that protrudes radially inward from the inner wall 192, and extends to the indoor condenser 18. Therefore, in addition to the function as the swirl generator, the guide 191 can have a function of facilitating the heat exchange of the working fluid in the indoor condenser 18. As a result, it is possible to achieve both improvement in the performance and the structure simplification of the cooling device 10.

Further, according to the present embodiment, as shown in FIGS. 3 to 5, the evaporator 14 and the outdoor condenser 16 corresponding to a flat tube section of the tubular member 12 extend to be inclined with respect to the horizontal direction of the vehicle 90 at an angle close to the horizontal direction than the up-down direction DR2. The evaporator 14 and the outdoor condenser 16 have a flat cross-sectional shape extended in the up-down direction DR2.

Therefore, the gas-liquid separation of the working fluid is improved in the evaporator 14 and the outdoor condenser 16. For example, as shown in FIG. 4, in the outdoor condenser 16, a heat transfer area can be easily increased for transferring heat from a gas-phase working fluid in the outdoor condenser 16 to a heat radiation object (specifically, the condensation heat diffusion plate 103). Thus, good condensation performance can be obtained. In the evaporator 14, the heat transfer area can be easily increased for transferring heat from the battery pack BP to the liquid-phase working fluid in the evaporator 14. Thus, good cooling performance can be obtained.

In addition, according to the present embodiment, as shown in FIG. 3, the evaporator 14 is fixed to the battery pack BP via the evaporation heat diffusion plate 102 in a state where heat can be conducted to the battery pack BP. Therefore, the evaporator 14 can receive heat uniformly from the entire battery side surface BPb of the battery pack BP. That is, it is possible to reduce the temperature unevenness of the battery pack BP and improve the cooling performance of the cooling device 10.

### Second Embodiment

A second embodiment of the present disclosure is described. The present embodiment will be explained primarily with respect to portions different from those of the first embodiment. In addition, explanations of the same or equivalent portions as those in the above embodiment will be omitted or simplified. The same applies to a description of embodiments as described later.

As shown in FIG. 7, in the present embodiment, the outdoor condensing fin 904 and the periphery structure are different from those of the first embodiment.

Specifically, the outdoor condensing fin 904 is provided outside the cabin space 90a so as to be exposed to the outside air, and facilitates heat radiation from the working fluid in the outdoor condenser 16 to the outside air. In this regard, the outdoor condensing fin 904 of the present embodiment is the same as the outdoor condensing fin 904 of the first embodiment.

However, the outdoor condensing fin 904 of this embodiment is joined to one surface 103a of the condensation heat diffusion plate 103, and is integrally formed with the condensation heat diffusion plate 103 and the outdoor condenser 16. That is, the cooling device 10 of the present embodiment is configured to include the outdoor condensing fin 904.

Further, the body panel 903a has a body through-hole 903d penetrating the body panel 903a. The body through-hole 903d is formed in a size that allows the outdoor condensing fin 904 to pass through the inside of the body through-hole 903d.

In the assembling step of the cooling device 10, when the condensation heat diffusion plate 103 is assembled to the body panel 903a, the outdoor condensing fin 904 is moved from the cabin space 90a side to the body panel 903a, as shown by an arrow Af in FIG. 7, and is inserted into the body through-hole 903d. Accordingly, in a state where the outdoor condensing fin 904 is exposed to the outside of the cabin space 90a through the body through-hole 903d, the condensation heat diffusion plate 103 is fixed to the body panel 903a to close the body through-hole 903d from a side adjacent to the cabin space 90a. This allows the outdoor condenser 16 to transfer heat to the outside air via the outdoor condensing fin 904.

Further, the one surface 103a of the condensation heat diffusion plate 103 has a fin peripheral portion 103d located to surround a portion where the outdoor condensing fin 904 is joined. The fin peripheral portion 103d is pressed against a body hole peripheral portion 903e that forms a periphery of the body through-hole 903d of the vehicle body 903. Thus, the fin peripheral portion 103d seals a clearance between the body hole peripheral portion 903e and the fin peripheral portion 103d. For example, a sealing material for waterproofing is provided between the fin peripheral portion 103d and the body hole peripheral portion 903e.

Therefore, in this embodiment, while the body through-hole 903d is provided, it is possible to restrict the infiltration of water from the body through-hole 903d into the cabin space 90a by the condensation heat diffusion plate 103. In addition, it is possible to arrange the outdoor condenser 16 on the side of the cabin space 90a with respect to the vehicle body 903 with a simple assembly structure while configuring such a waterproof structure.

Aside from the above described aspects, the present embodiment is the same as the first embodiment. Further, in the present embodiment, the same effects as the first embodiment described above can be obtained in the same manner as in the first embodiment.

### Third Embodiment

A third embodiment is described. The present embodiment will be explained mainly with respect to portions different from those of the first embodiment.

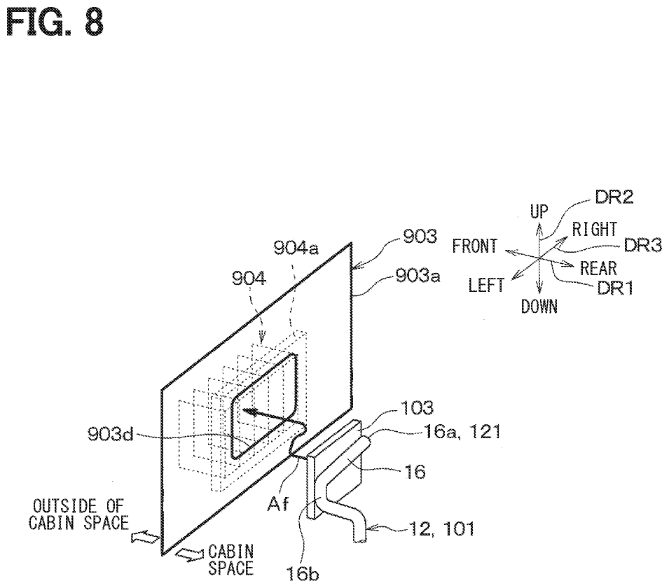

As shown in FIG. 8, in the present embodiment, the structure of the outdoor condensing fin 904 and its surroundings are different from those of the first embodiment.

Specifically, the body panel 903a of the present embodiment has a body through-hole 903d penetrating the body panel 903a.

The outdoor condensing fin 904 is provided outside the cabin space 90a so as to be exposed to the outside air, and facilitates heat radiation from the working fluid in the outdoor condenser 16 to the outside air. In this regard, the outdoor condensing fin 904 of the present embodiment is the same as the outdoor condensing fin 904 of the first embodiment.

However, the outdoor condensing fin 904 of this embodiment has a flat substrate portion 904a along the body panel 903a, and the substrate portion 904a is joined to the body panel 903a. More specifically, the substrate portion 904a is fixed to the body panel 903a so as to cover the body through-hole 903d from the side opposite to the cabin space 90a (i.e., from a side adjacent to the engine room 90f). Further, a joint portion between the substrate portion 904a and the body panel 903a surrounds the body through-hole 903d over the entire circumference thereof, and is waterproofed by, for example, welding or sandwiching a waterproof sealing material.

Further, the outdoor condenser 16 is fixed to a side of the outdoor condensing fin 904 adjacent to the cabin space 90a via the inside of the body through-hole 903d so as to be able to conduct heat to the outdoor condensing fin 904. Specifically, the condensation heat diffusion plate 103 joined with the outdoor condenser 16 is fixed to the substrate portion 904a of the outdoor condensing fin 904 through the inside of the body through-hole 903d so that heat can be conducted to the outdoor condensing fin 904. This allows the outdoor condenser 16 to transfer heat to the outside air via the outdoor condensing fin 904. The condensation heat diffusion plate 103 and the substrate portion 904a of the outdoor condensing fin 904 may be in direct contact with each other. For example, a heat conductive sheet material or grease is interposed between the condensation heat diffusion plate 103 and the substrate portion 904a to increase the thermal conductivity between the condensation heat diffusion plate 103 and the substrate portion 904a.

Aside from the above described aspects, the present embodiment is the same as the first embodiment. Further, in the present embodiment, the same effects as the first embodiment described above can be obtained in the same manner as in the first embodiment.

Further, according to the present embodiment, the substrate portion 904a of the outdoor condensing fin 904 is fixed to the body panel 903a so as to close the body through-hole 903d from the side opposite to the cabin space 90a. Therefore, in the present embodiment, while the body through-hole 903d is provided, infiltration of water from the body through-hole 903d into the cabin space 90a can be restricted by the outdoor condensing fin 904.

Further, according to the present embodiment, the outdoor condenser 16 is fixed to a side of the outdoor condensing fin 904 adjacent to the cabin space 90a via the inside of the body through-hole 903d so as to be able to conduct heat to the outdoor condensing fin 904. This allows the outdoor condenser 16 to transfer heat to the outside air via the outdoor condensing fin 904. Therefore, it is possible to arrange the outdoor condenser 16 on the side of the cabin space 90a with respect to the vehicle body 903 with a simple assembly structure.

### Fourth Embodiment

A fourth embodiment is described. The present embodiment will be explained mainly with respect to portions different from those of the first embodiment.

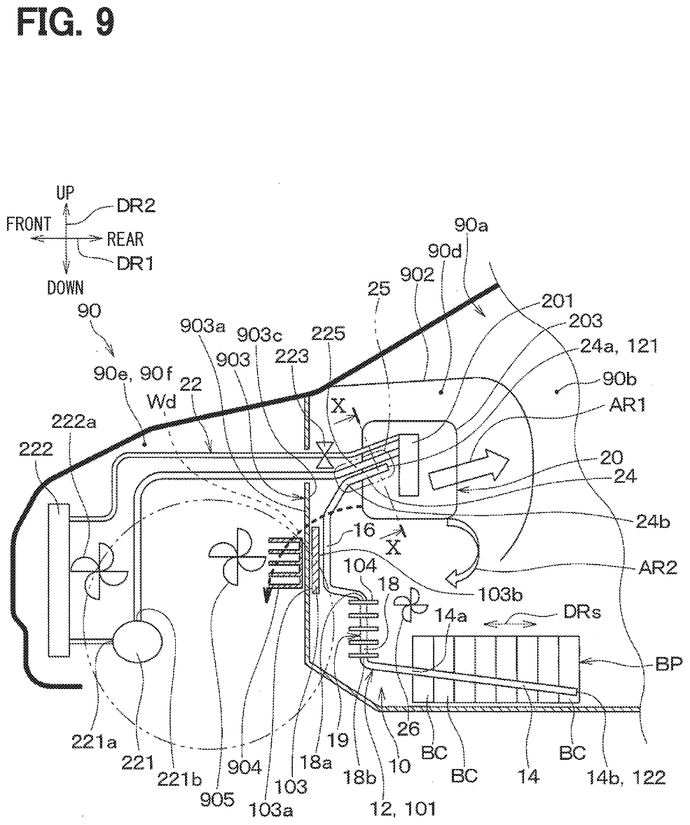

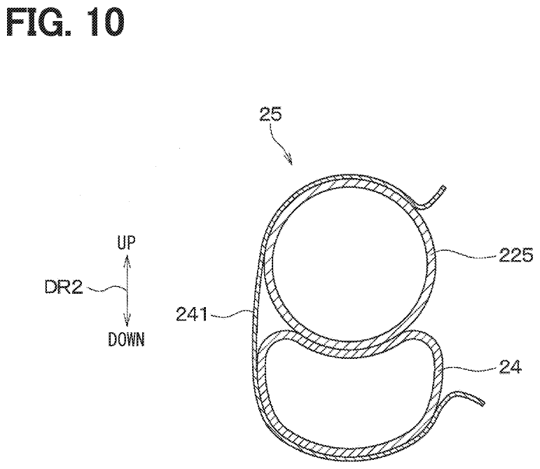

As shown in FIGS. 9 and 10, the cooling device 10 of the present embodiment includes a refrigerant pipe condenser 24 in addition to the outdoor condenser 16 and the indoor condenser 18. The refrigerant pipe condenser 24 is a part of the sealed container 101 and is disposed above the evaporator 14. The present embodiment is different from the first embodiment in this point.

Specifically, the air conditioning unit 20 uses a vapor compression refrigeration cycle circuit 22 in which refrigerant circulates to cool air for air conditioning. The refrigeration cycle circuit 22 includes a compressor 221, an outdoor condenser 222 disposed at a front part of the engine room 90f, an expansion valve 223, an evaporator 201, and a pipe connecting them. Note that arrows AR1 and AR2 in FIG. 9 represent air blown out by the air conditioning unit 20.

In the refrigeration cycle circuit 22, the compressor 221 compresses and discharges the refrigerant. The refrigerant discharged from a discharge port 221a of the compressor 221 is sucked into a suction port 221b of the compressor 221 through the outdoor condenser 222, the expansion valve 223, and the evaporator 201 in this order. In the process of circulating the refrigerant in the refrigeration cycle circuit 22, heat is radiated from the refrigerant to air flow generated when the vehicle travels, which is the outside air, in the outdoor condenser 222. Outside air may be forcibly blown to the outdoor condenser 222 by the outdoor blower 222a in the engine room 90f. The refrigerant is decompressed and expanded by the expansion valve 223. In the evaporator 201, air flowing through the air conditioning unit 20 and the refrigerant exchange heat, such that the air is cooled and the refrigerant evaporates.

The refrigerant pipe condenser 24 of the present embodiment is disposed in the cabin space 90a. The refrigerant pipe condenser 24 is a part of the tubular member 12. The evaporator 14, the indoor condenser 18, the outdoor condenser 16, and the refrigerant pipe condenser 24 are connected in series in this order. At the same time, the evaporator 14, the indoor condenser 18, the outdoor condenser 16, and the refrigerant pipe condenser 24 are arranged in this order from the lower side of the vehicle 90. Therefore, the lower end 16b of the outdoor condenser 16 is connected to the upper end 18a of the indoor condenser 18, and the upper end 14a of the evaporator 14 is connected to the lower end 18b of the indoor condenser 18. Further, the upper end 16a of the outdoor condenser 16 is connected to the lower end 24b of the refrigerant pipe condenser 24.

The refrigerant pipe condenser 24 is connected to a predetermined heat absorbing portion 225 included in the refrigeration cycle circuit 22 so as to be able to conduct heat. Thus, the refrigerant pipe condenser 24 and the predetermined heat absorbing portion 225 constitute a heat exchanger 25 for exchanging heat between the refrigerant and the working fluid.

More specifically, the predetermined heat absorbing portion 225 has a tubular shape, and is a part of a piping member that connects the evaporator 201 to the suction port 221b of the compressor 221 in the refrigeration cycle circuit 22. Further, the refrigerant pipe condenser 24 is disposed below the predetermined heat absorbing portion 225. At the same time, the refrigerant pipe condenser 24 is fixed and pressed against the predetermined heat absorbing portion 225 by a clip 241 so as to conduct heat. The method of fixing the refrigerant pipe condenser 24 to the predetermined heat absorbing portion 225 is such clipping by the clip 241. Thus, the refrigerant pipe condenser 24 is detachable from the predetermined heat absorbing portion 225.

While the refrigerant pipe condenser 24 and the predetermined heat absorbing portion 225 may be in direct contact with each other, for example, a heat conductive sheet material or grease is interposed between the refrigerant pipe condenser 24 and the predetermined heat absorbing portion 225 to increase the thermal conductivity between the refrigerant pipe condenser 24 and the predetermined heat absorbing portion 225.

Since the refrigerant pipe condenser 24 is thus fixed, the refrigerant pipe condenser 24 radiates heat from the working fluid vaporized in the evaporator 14 to the refrigerant flowing in the predetermined heat absorbing portion 225 of the refrigeration cycle circuit 22. Thereby, the refrigerant pipe condenser 24 condenses the working fluid. Therefore, the refrigerant pipe condenser 24 corresponds to another condenser that condenses the working fluid by releasing heat from the working fluid to a predetermined heat radiation object other than the outside air. In the case of the refrigerant pipe condenser 24, the predetermined heat radiation object is the refrigerant flowing in the predetermined heat absorbing portion 225. As described above, in the present embodiment, the refrigerant pipe condenser 24, in addition to the indoor condenser 18, corresponds to another condenser, and the sealed container 101 has a plurality of other condensers.

As shown in FIG. 9, the refrigerant pipe condenser 24 is arranged in the same posture as the outdoor condenser 16. That is, the refrigerant pipe condenser 24 is arranged so as to be inclined with respect to the horizontal direction of the vehicle 90 at an angle closer to the horizontal direction of the vehicle 90 than the up-down direction DR2. Specifically, the refrigerant pipe condenser 24 extends to be slightly inclined to the horizontal direction of the vehicle 90 such that the lower end 24b of the refrigerant pipe condenser 24 is located lower than the tube end 121 that is the upper end 24a of the refrigerant pipe condenser 24. In other words, the refrigerant pipe condenser 24 extends to be slightly inclined with respect to the horizontal direction of the vehicle 90 so that the refrigerant pipe condenser 24 is located lower as approaching the lower end 24b from the upper end 24a.

Accordingly, the flow of the gas-phase and liquid-phase working fluid in the refrigerant pipe condenser 24 becomes the same as that in the outdoor condenser 16 described above due to the inclination of the refrigerant pipe condenser 24. In addition, since the refrigerant pipe condenser 24 is fixed along the predetermined heat absorbing portion 225 of the refrigeration cycle circuit 22, the predetermined heat absorbing portion 225 is also held in an inclined manner similarly to the refrigerant pipe condenser 24.

In the present embodiment, an indoor blower 26 is provided for cooling the indoor condenser 18 with air. The indoor blower 26 is appropriately operated to blow the inside air to the indoor fin 104 and the indoor condenser 18.

Aside from the above described aspects, the present embodiment is the same as the first embodiment. Further, in the present embodiment, the same effects as the first embodiment described above can be obtained in the same manner as in the first embodiment.

Further, according to the present embodiment, the refrigerant pipe condenser 24 is disposed below the predetermined heat absorbing portion 225 of the refrigeration cycle circuit 22 and is fixed so as to be able to conduct heat to the predetermined heat absorbing portion 225. Since liquid refrigerant and oil flow in the predetermined heat absorbing portion 225 in a downwardly biased manner, the working fluid in the refrigerant pipe condenser 24 can easily radiate heat to the liquid refrigerant and oil. Further, in the refrigerant pipe condenser 24, the gas-phase working fluid is more likely to be biased upward, i.e., toward the predetermined heat absorbing portion 225 than the liquid-phase working fluid. For this reason, it is possible to increase the condensation performance of the refrigerant pipe condenser 24 by preferentially using the lower part of the predetermined heat absorbing portion 225 which easily absorbs heat.

Note that the present embodiment is a modification of the first embodiment, but it is possible to combine the present embodiment with the second embodiment or the third embodiment described above.

### Fifth Embodiment

A fifth embodiment is described. The present embodiment will be explained mainly with respect to portions different from those of the fourth embodiment.

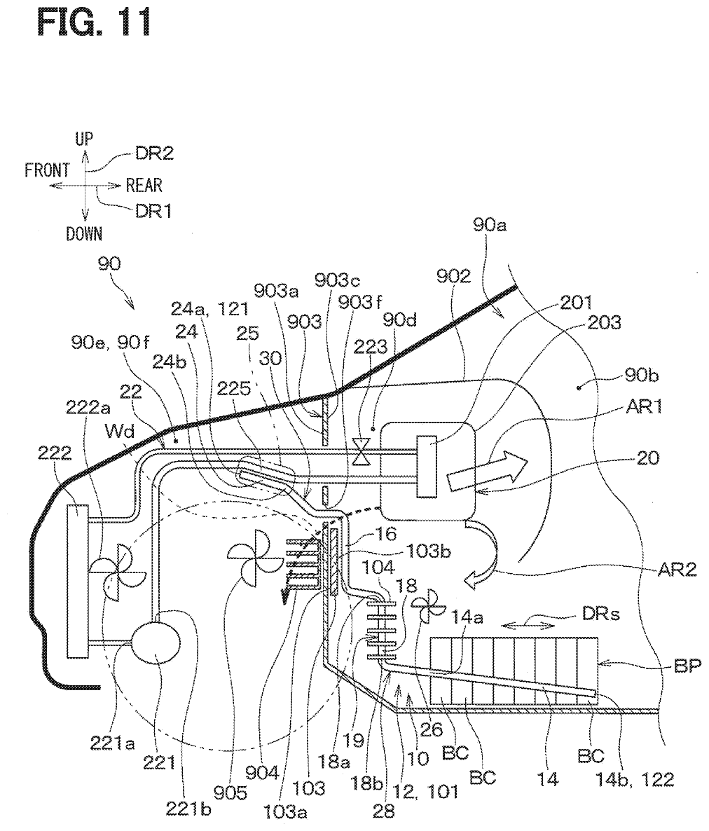

As shown in FIG. 11, in the present embodiment, the refrigerant pipe condenser 24 and the predetermined heat absorbing portion 225 of the refrigeration cycle circuit 22 are arranged in the engine room 90f outside the cabin space 90a. A body through-hole 903f is formed in the vehicle body 903 in order to arrange the refrigerant pipe condenser 24 in the engine room 90f. The present embodiment is different from the fourth embodiment in this point. The method of fixing the refrigerant pipe condenser 24 to the predetermined heat absorbing portion 225 is clipping with the clip 241 as in the fourth embodiment.

In the present embodiment, a part of the sealed container 101 extends outside the cabin space 90a. That is, when attention is paid to an arrangement place in the vehicle 90, the sealed container 101 has an indoor arrangement part 28 arranged in the cabin space 90a and an outdoor arrangement part 30 arranged outside the cabin space 90a. The evaporator 14, the outdoor condenser 16, and the indoor condenser 18 are included in the indoor arrangement part 28. The refrigerant pipe condenser 24 is included in the outdoor arrangement part 30.

Further, the outdoor arrangement part 30 is arranged outside the cabin space 90a in a state where the outdoor arrangement part 30 is led out of the cabin space 90a through the body through-hole 903f. Further, the body through-hole 903f is formed in a size that allows the outdoor arrangement part 30 to pass through the inside of the body through-hole 903f.

Therefore, if the outdoor arrangement part 30 is removed from the predetermined heat absorbing portion 225, the outdoor arrangement part 30 can be taken in from the outside of the cabin space 90a into the cabin space 90a through the body through-hole 903f. Therefore, the entire sealed container 101 including the outdoor arrangement part 30 can be easily configured so as to be detachable toward the cabin space 90a with respect to the vehicle body 903. In addition, a gap between the tubular member 12 and the body through-hole 903f is sealed by, for example, a seal grommet.

Aside from the above described aspects, the present embodiment is the same as the fourth embodiment. Further, in the present embodiment, the same effects as the fourth embodiment described above can be obtained in the same manner as in the fourth embodiment.

### Sixth Embodiment

A sixth embodiment is described. The present embodiment will be explained mainly with respect to portions different from those of the fourth embodiment.

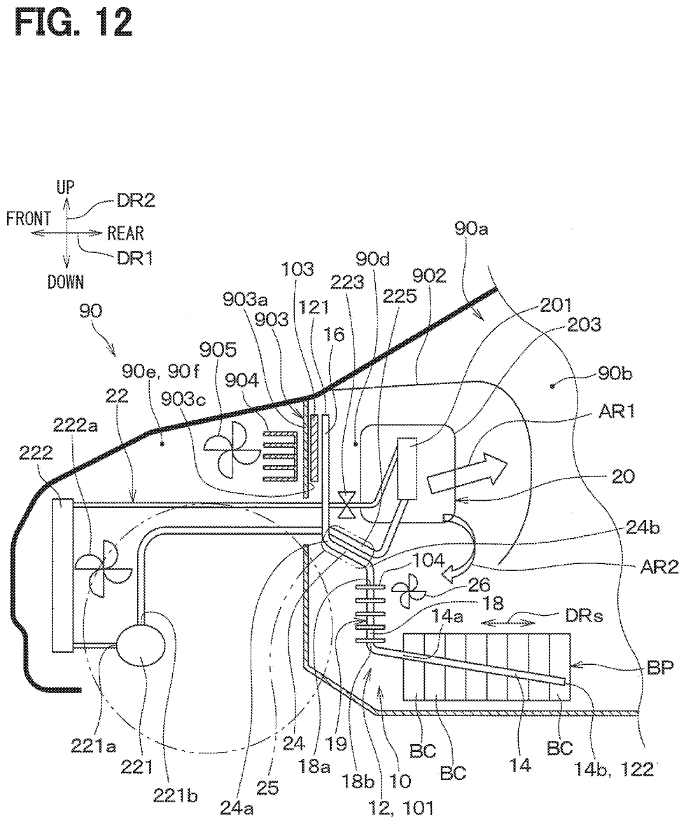

As shown in FIG. 12, in the present embodiment, the arrangement of the outdoor condenser 16 and the refrigerant pipe condenser 24 in the sealed container 101 is different from that of the fourth embodiment. The method of fixing the refrigerant pipe condenser 24 to the predetermined heat absorbing portion 225 is clipping with the clip 241 as in the fourth embodiment.

Specifically, the evaporator 14, the indoor condenser 18, the refrigerant pipe condenser 24, and the outdoor condenser 16 are connected in series in this order. At the same time, the evaporator 14, the indoor condenser 18, the refrigerant pipe condenser 24, and the outdoor condenser 16 are arranged in this order from the lower side of the vehicle 90. Therefore, the lower end 16b of the outdoor condenser 16 is connected to the upper end 24a of the refrigerant pipe condenser 24, and the lower end 24b of the refrigerant pipe condenser 24 is connected to the upper end 18a of the indoor condenser 18. Further, the lower end 18b of the indoor condenser 18 is connected to the upper end 14a of the evaporator 14.

Aside from the above described aspects, the present embodiment is the same as the fourth embodiment. Further, in the present embodiment, the same effects as the fourth embodiment described above can be obtained in the same manner as in the fourth embodiment.

### Seventh Embodiment

A seventh embodiment is described. The present embodiment will be explained mainly with respect to portions different from those of the first embodiment.

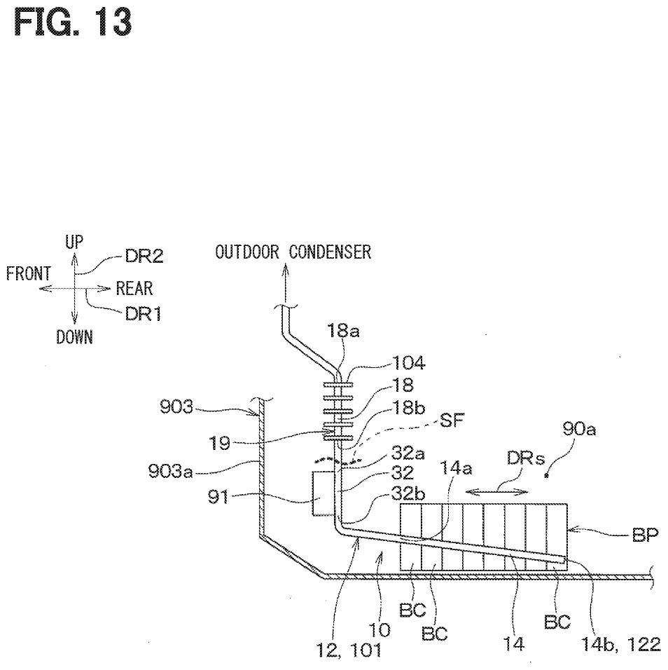

As shown in FIG. 13, in the present embodiment, a heating device 91 different from the battery pack BP is provided in the cabin space 90a. The cooling device 10 includes a second evaporator 32 for cooling the heating device 91 in addition to the evaporator 14 as a first evaporator connected to the battery pack BP. The present embodiment differs from the first embodiment in these points. The second evaporator 32 is provided between the first evaporator 14 and the indoor condenser 18, and the arrangement of the outdoor condenser 16 is the same as in the first embodiment.

Specifically, the second evaporator 32 forms a part of the tubular member 12, and is disposed in the cabin space 90a. The first evaporator 14, the second evaporator 32, the indoor condenser 18, and the outdoor condenser 16 are connected in series in this order. At the same time, the first evaporator 14, the second evaporator 32, the indoor condenser 18, and the outdoor condenser 16 are arranged in this order from the lower side of the vehicle 90. Therefore, the lower end 16b of the outdoor condenser 16 is connected to the upper end 18a of the indoor condenser 18, and the lower end 18b of the indoor condenser 18 is connected to the upper end 32a of the second evaporator 32. The lower end 32b of the second evaporator 32 is connected to the upper end 14a of the evaporator 14.

The second evaporator 32 is connected to the heating device 91 so as to be able to conduct heat. The heating device 91 is an electric component that generates heat, and is, for example, a relay, an ECU, a charger, a DCDC converter, or the like. The heating device 91 is allowed to have a higher temperature than the battery pack BP. For example, the heating device 91 has a higher temperature than the battery pack BP during the heat generation of the heating device 91. The second evaporator 32 and the heating device 91 may be in direct contact with each other. However, for example, a heat conductive sheet material or grease is interposed between the second evaporator 32 and the heating device 91, to increase the thermal conductivity.

The second evaporator 32 evaporates the working fluid by causing the working fluid in the second evaporator 32 to absorb heat from the heating device 91. Further, the second evaporator 32 is arranged above the first evaporator 14 and below the liquid surface SF of the working fluid formed in the sealed container 101 when the thermosiphon is not operated.

Therefore, in the second evaporator 32, the liquid-phase working fluid can easily absorb the heat of the heating device 91, and the working fluid can be favorably evaporated. Then, the air bubbles generated in the second evaporator 32 due to the heat of the heating device 91 can flow out to the indoor condenser 18 instead of the first evaporator 14. That is, it is possible to restrict bubbles generated by the heat of the heating device 91 from radiating heat to the battery pack BP.

Aside from the above described aspects, the present embodiment is the same as the first embodiment. Further, in the present embodiment, the same effects as the first embodiment described above can be obtained in the same manner as in the first embodiment. The present embodiment is a modification of the first embodiment and can also be combined with any of the second to the sixth embodiments described above.

### Eighth Embodiment

An eighth embodiment is described. The present embodiment will be explained mainly with respect to portions different from those of the first embodiment.

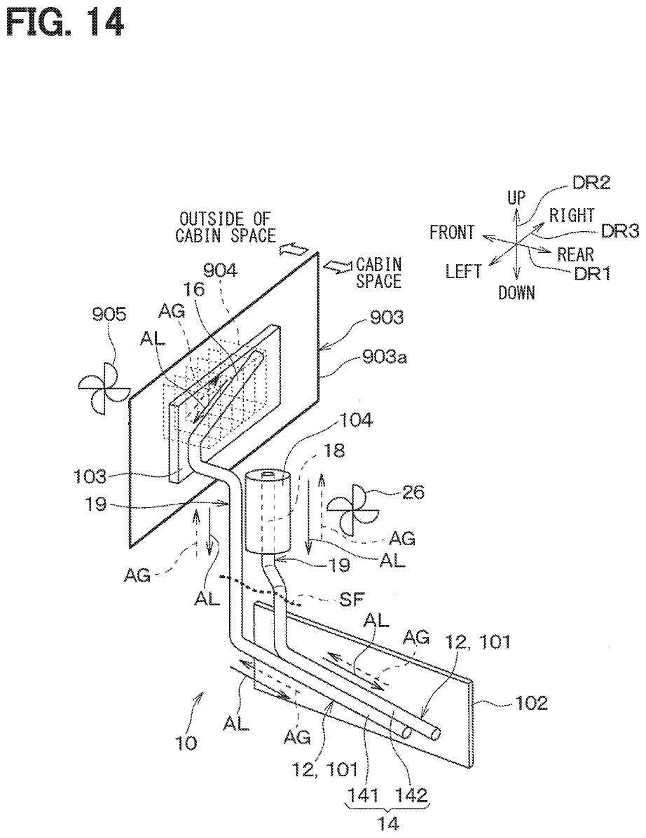

As shown in FIG. 14, the cooling device 10 of the present embodiment has two sealed containers 101. Each of the two sealed containers 101 is formed of a different tubular member 12. That is, the cooling device 10 has a plurality of tubular members 12, each of which is a single tube. The present embodiment is different from the first embodiment in this point.

Since the battery pack BP of the present embodiment is the same as that of the first embodiment, the illustration of the battery pack BP is omitted in FIG. 14. The flow of the gas-phase working fluid in the sealed container 101 is indicated by a broken-line arrow AG, and the flow of the liquid-phase working fluid is indicated by a solid-line arrow AL. FIG. 14 shows the liquid level SF of the working fluid when the thermosiphon is not operated. Further, the method of fixing the condensation heat diffusion plate 103 to the body panel 903a is the same as that of the first embodiment with nuts. However, in FIG. 14, the bolts 903b (see FIG. 3) are omitted. The same applies to the drawings described later that employ the same illustration method as that of FIG. 14.

Specifically, a first one of the two sealed containers 101 includes a first evaporating tube 141 included in the evaporator 14 and an outdoor condenser 16 disposed above the first evaporating tube 141. The first evaporating tube 141 and the outdoor condenser 16 are connected in series with each other, and are included in one tubular member 12 that forms the first sealed container 101. Therefore, in the first sealed container 101, the gas-phase working fluid evaporated in the first evaporating tube 141 by the heat of the battery pack BP rises and flows to the outdoor condenser 16. At the same time, the liquid-phase working fluid condensed in the outdoor condenser 16 flows down to the first evaporating tube 141.

The other sealed container 101 of the two sealed containers 101 includes a second evaporating tube 142 included in the evaporator 14 and the indoor condenser 18 disposed above the second evaporating tube 142. The second evaporating tube 142 and the indoor condenser 18 are connected in series with each other, and are included in the other tubular member 12 that forms the other sealed container 101. Therefore, in the other sealed container 101, the gas-phase working fluid evaporated in the second evaporating tube 142 by the heat of the battery pack BP rises and flows to the indoor condenser 18. At the same time, the liquid-phase working fluid condensed in the indoor condenser 18 flows down to the second evaporating tube 142. In addition, the first evaporating tube 141 and the second evaporating tube 142 are disposed so as to be inclined with respect to the horizontal direction of the vehicle 90, similarly to the evaporator 14 of the first embodiment.

Aside from the above described aspects, the present embodiment is the same as the first embodiment. Further, in the present embodiment, the same effects as the first embodiment described above can be obtained in the same manner as in the first embodiment.

Further, according to the present embodiment, the outdoor condenser 16 and the indoor condenser 18 are connected to the first evaporating tube 141 and the second evaporating tube 142, respectively, so that the outdoor condenser 16 and the indoor condenser 18 can be easily placed to be separated from each other. That is, the flexibility in mounting the outdoor condenser 16 and the indoor condenser 18 can be improved.

The present embodiment is a modification of the first embodiment and can also be combined with any of the second to the seventh embodiments described above.

### Ninth Embodiment

A ninth embodiment is described. The present embodiment will be explained primarily with respect to portions different from those of the eighth embodiment.

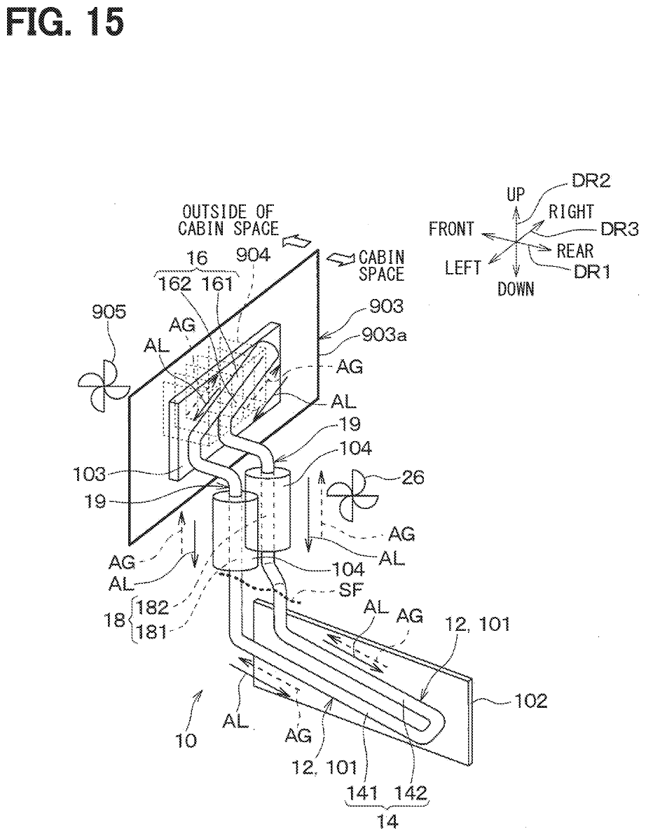

As shown in FIG. 15, the sealed container 101 of the present embodiment is configured by a loop-shaped tubular member 12. The present embodiment is different from the eighth embodiment in this point.

Specifically, the evaporator 14 has a first evaporating tube 141 and a second evaporating tube 142. The outdoor condenser 16 has a first outdoor condensing tube 161 and a second outdoor condensing tube 162. The indoor condenser 18 has a first indoor condensing tube 181 and a second indoor condensing tube 182.

The first evaporating tube 141, the first indoor condensing tube 181 and the first outdoor condensing tube 161 are connected in series, and the first evaporating tube 141, the first indoor condensing tube 181, and the first outdoor condensing tube 161 are arranged in this order from the lower side of the vehicle 90.

Accordingly, the gas-phase working fluid evaporated in the first evaporating tube 141 by the heat of the battery pack BP rises and flows to the first indoor condensing tube 181. The gas-phase working fluid remaining without being condensed in the first indoor condensing tube 181 flows from the first indoor condensing tube 181 to the first outdoor condensing tube 161. At the same time, the liquid-phase working fluid condensed in the first outdoor condensing tube 161 flows down to the first evaporating tube 141. Then, the liquid-phase working fluid condensed in the first indoor condensing tube 181 also flows down to the first evaporating tube 141.

The second evaporating tube 142, the second indoor condensing tube 182, and the second outdoor condensing tube 162 are connected in series, and the second evaporating tube 142, the second indoor condensing tube 182 and the second outdoor condensing tube 162 are connected in this order from the lower side of the vehicle 90.

Accordingly, the gas-phase working fluid evaporated in the second evaporating tube 142 by the heat of the battery pack BP rises and flows to the second indoor condensing tube 182. The gas-phase working fluid remaining without being condensed in the second indoor condensing tube 182 flows from the second indoor condensing tube 182 to the second outdoor condensing tube 162. At the same time, the liquid-phase working fluid condensed in the second outdoor condensing tube 162 flows down to the second evaporating tube 142. Then, the liquid-phase working fluid condensed in the second indoor condensing tube 182 also flows down to the second evaporating tube 142.

Since the tubular member 12 has the loop shape, the lower end of the first evaporating tube 141 and the lower end of the second evaporating tube 142 are connected to each other, and the upper end of the first outdoor condensing tube 161 and the upper end of the second outdoor condensing tube 162 are connected to each other.

In addition, the first evaporating tube 141 and the second evaporating tube 142 are disposed so as to be inclined with respect to the horizontal direction of the vehicle 90, similarly to the evaporator 14 of the first embodiment. Further, the first outdoor condensing tube 161 and the second outdoor condensing tube 162 are arranged so as to be inclined with respect to the horizontal direction of the vehicle 90, similarly to the outdoor condenser 16 of the first embodiment.

Aside from the above described aspects, the present embodiment is the same as the eighth embodiment. Further, in the present embodiment, effects similar to those of the eighth embodiment described above can be obtained in the same manner as in the eighth embodiment.

Further, according to the present embodiment, since the upper end of the first outdoor condensing tube 161 and the upper end of the second outdoor condensing tube 162 are connected to each other, the internal pressure of the first outdoor condensing tube 161 and the internal pressure of the second outdoor condensing tube 162 are equal with each other. This makes it possible to stabilize the liquid level SF of the working fluid during operation of the thermosiphon.

### Tenth Embodiment

A tenth embodiment is described. The present embodiment will be explained primarily with respect to portions different from those of the ninth embodiment.

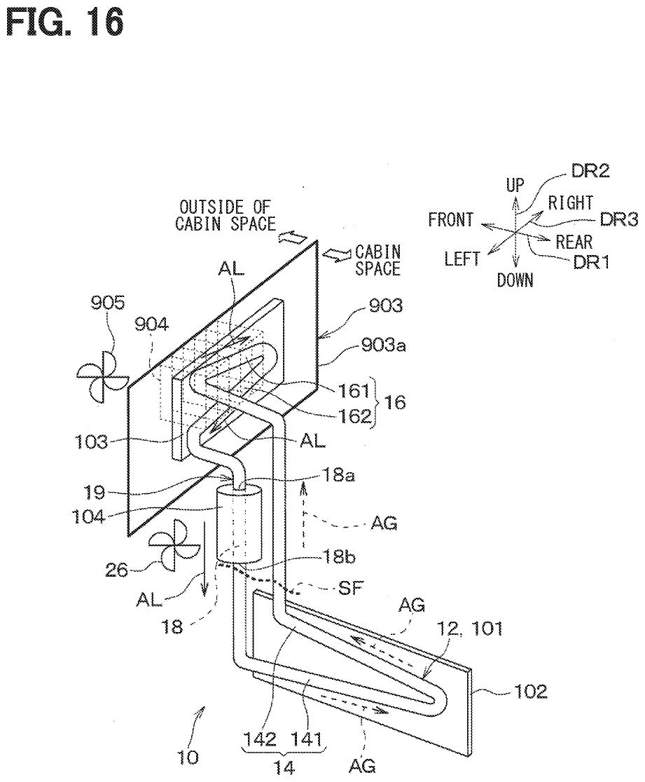

As shown in FIG. 16, the sealed container 101 of the present embodiment is the same as the ninth embodiment in that the container 101 is configured by a loop-shaped tubular member 12. However, the cooling device 10 of the present embodiment is configured as a loop-type thermosiphon in which a working fluid circulates as rotating. The number of the indoor condensers 18 is one. This embodiment is different from the ninth embodiment in these points.

Specifically, the first evaporating tube 141 and the second evaporating tube 142 are arranged so as to extend to be inclined with respect to the horizontal direction of the vehicle 90. This is the same as the evaporator 14 of the ninth embodiment, except that the second evaporating tube 142 is disposed above the first evaporating tube 141, and the upper end of the first evaporating tube 141 is connected with the lower end of the second evaporating tube 142. For this reason, the first evaporating tube 141 and the second evaporating tube 142 connected in series to each other form a V-shaped tube. Therefore, both the working fluid evaporated in the first evaporating tube 141 and the working fluid evaporated in the second evaporating tube 142 flow out from the upper end of the second evaporating tube 142.

In addition, the first outdoor condensing tube 161 and the second outdoor condensing tube 162 are arranged so as to extend to be inclined with respect to the horizontal direction of the vehicle 90. This is the same as the outdoor condenser 16 of the ninth embodiment, except that the second outdoor condensing tube 162 is disposed below the first outdoor condensing tube 161, and the lower end of the first outdoor condensing tube 161 is connected to the upper end of the second outdoor condensing tube 162. Therefore, the first outdoor condensing tube 161 and the second outdoor condensing tube 162 connected in series with each other form a V-shaped tube part. Therefore, both the working fluid condensed in the first outdoor condensing tube 161 and the working fluid condensed in the second outdoor condensing tube 162 flow out from the lower end of the second outdoor condensing tube 162.

Further, the upper end of the second evaporating tube 142 is connected to the upper end of the first outdoor condensing tube 161. The lower end of the second outdoor condensing tube 162 is connected to the upper end 18a of the indoor condenser 18, and the lower end 18b of the indoor condenser 18 is connected to the lower end of the first evaporating tube 141.

As described above, the first evaporating tube 141, the second evaporating tube 142, the first outdoor condensing tube 161, the second outdoor condensing tube 162, and the indoor condenser 18 are annularly connected in this order. Therefore, the gas-phase working fluid evaporated in the first evaporating tube 141 and the second evaporating tube 142 rises and flows to the first outdoor condensing tube 161. The gas-phase working fluid that has flowed into the first outdoor condensing tube 161 is condensed in the first outdoor condensing tube 161, the second outdoor condensing tube 162, and the indoor condenser 18. The condensed working fluid flows down, and returns to the first evaporating tube 141 from the lower end of the first evaporating tube 141.

Aside from the above described aspects, the present embodiment is the same as the ninth embodiment. Further, in the present embodiment, effects similar to those of the ninth embodiment described above can be obtained in the same manner as in the ninth embodiment.

### Eleventh Embodiment

An eleventh embodiment is described. The present embodiment will be explained mainly with respect to portions different from those of the first embodiment.

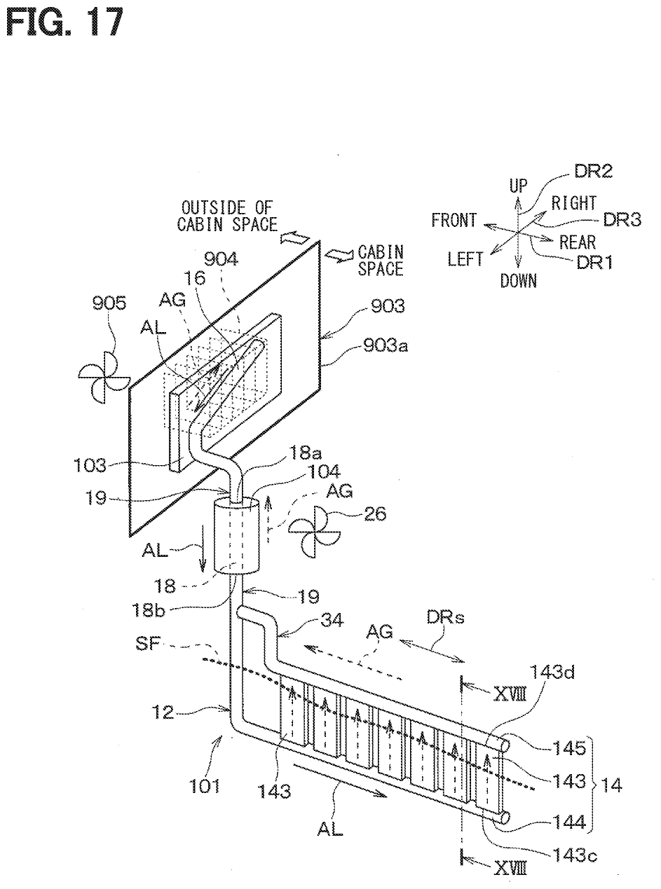

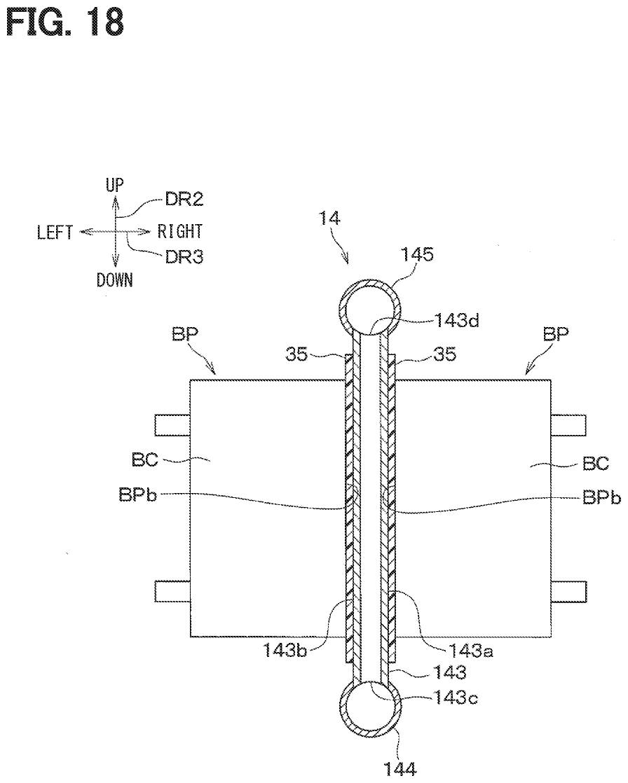

As shown in FIGS. 17 and 18, in the present embodiment, the configuration of the evaporator 14 is different from that of the first embodiment. In this embodiment, two battery packs BP are provided.

Specifically, the cooling device 10 of the present embodiment does not include the evaporation heat diffusion plate 102. The sealed container 101 of the present embodiment has the first tubular member 12, the second tubular member 34, and plural evaporating tubes 143. The evaporator 14 has a lower flow path 144 included in the first tubular member 12, an upper flow path 145 included in the second tubular member 34, and the evaporating tubes 143. The first tubular member 12 has the upper and lower pipe 19 including the indoor condenser 18 and the outdoor condenser 16 in addition to the lower flow path 144 of the evaporator 14.

The evaporating tubes 143 extend in the up-down direction DR2, and are arranged side by side in the cell stacking direction DRs. Each of the evaporating tubes 143 has a flat cross-sectional shape whose longitudinal direction is the cell stacking direction DRs. The battery pack BP is connected to the respective flat surfaces 143a and 143b of the evaporating tube 143 in a state where the battery side surface BPb is pressed via a heat conductive sheet material 35. Thereby, the battery pack BP is fixed to the evaporating tubes 143 of the evaporator 14 so as to be able to conduct heat.

The lower ends 143c of the evaporating tubes 143 are connected to the lower flow path 144, such that the evaporating tubes 143 communicate with the lower flow path 144 at the lower ends 143c. The upper ends 143d of the evaporating tubes 143 are connected to the upper flow path 145, and the evaporating tubes 143 communicate with the upper flow path 145 at the upper ends 143d.

The lower flow path 144 is formed to extend in the cell stacking direction DRs, and is connected to the lower end 18b of the indoor condenser 18 at one side in the cell stacking direction DRs. The lower flow path 144 is located below the battery pack BP and the evaporating tubes 143 and is spaced from the battery pack BP and the heat conductive sheet material 35.

The upper flow path 145 is formed to extend in the cell stacking direction DRs, and is located above the lower flow path 144, the battery pack BP, and the evaporating tubes 143. The upper flow path 145 is connected to a lower part of the upper and lower pipe 19 below the indoor condenser 18 at one side in the cell stacking direction DRs. More specifically, the second tubular member 34 including the upper flow path 145 is connected to the upper and lower pipe 19 from the side of the upper and lower pipe 19. Thus, the upper flow path 145 communicates with the upper and lower pipe 19.

In the cooling device 10 of the present embodiment configured as described above, as shown in FIG. 17, when the evaporating tube 143 receives heat from the battery pack BP, the liquid-phase working fluid in the evaporating tube 143 is evaporated by the heat. Thereby, the battery pack BP is cooled. The gas-phase working fluid evaporated in the evaporating tube 143 rises, and flows into the upper flow path 145. The gas-phase working fluid flows from the upper flow path 145 to the indoor condenser 18 of the first tubular member 12. The flow of the working fluid between the indoor condenser 18 and the outdoor condenser 16 is the same as in the first embodiment. The filling amount of the working fluid is adjusted in advance so that, for example, the working fluid in the liquid phase enters the evaporating tube 143 during the non-operation time and the operation time of the thermosiphon.

The liquid-phase working fluid flows down from the indoor condenser 18 into the lower flow path 144 of the evaporator 14. The working fluid in the liquid phase flowing down hardly enters the second tubular member 34 depending on the connection direction of the second tubular member 34 to the upper and lower pipe 19. The liquid-phase working fluid that has flowed into the lower flow path 144 is distributed from the lower flow path 144 to each of the evaporating tubes 143. As described above, the phase change between the liquid phase and the gas phase of the working fluid is repeated in the sealed container 101, whereby the battery pack BP is cooled.

The flow of the gas-phase working fluid and the flow of the liquid-phase working fluid are separated as described above, so that the working fluid can flow smoothly in the evaporator 14. As a result, the cooling capacity of the cooling device 10 can be improved.

Aside from the above described aspects, the present embodiment is the same as the first embodiment. Further, in the present embodiment, the same effects as the first embodiment described above can be obtained in the same manner as in the first embodiment. The present embodiment is a modification of the first embodiment and can also be combined with any of the second to the seventh embodiments described above.

### Twelfth Embodiment

A twelfth embodiment is described. This embodiment is a combination of the tenth embodiment and the eleventh embodiment.

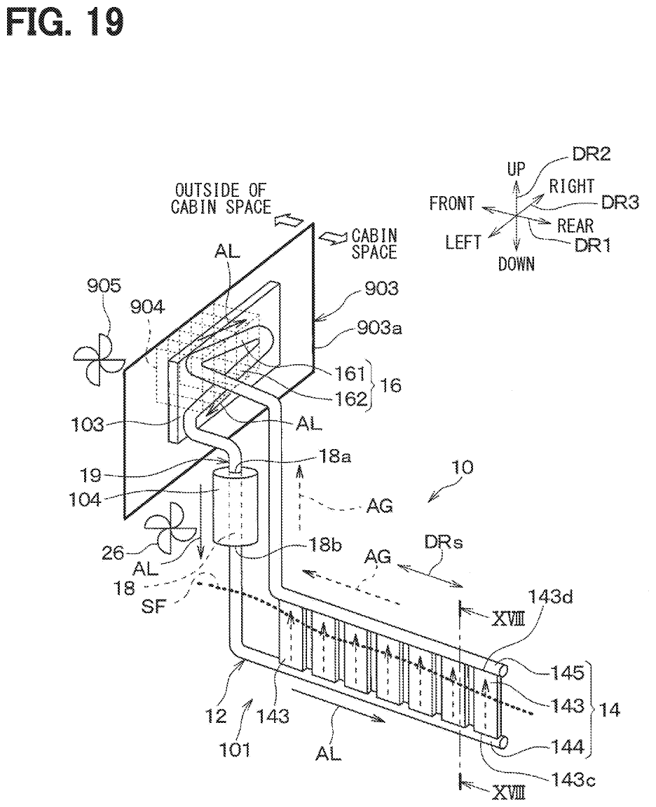

In the present embodiment, as shown in FIG. 19, the sealed container 101 has a tubular member 12 extending in a U-shape and plural evaporating tubes 143. The lower flow path 144 and the upper flow path 145 of the evaporator 14 are included in the tubular member 12. Note that FIG. 18 is a cross-sectional view taken along a line XVIII-XVIII of FIG. 17, but also shows a cross section taken along a line XVIII-XVIII of FIG. 19.

In the present embodiment, the configuration of the evaporator 14 is the same as that of the eleventh embodiment, and the configuration of the outdoor condenser 16 is the same as that of the tenth embodiment.

In addition, the lower flow path 144 of the present embodiment is connected to the lower end 18b of the indoor condenser 18 as in the eleventh embodiment. Unlike the eleventh embodiment, the upper flow path 145 is connected to the upper end of the first outdoor condensing tube 161.

Accordingly, the gas-phase working fluid evaporated in the evaporating tube 143 rises, and flows into the upper flow path 145. The gas-phase working fluid flows from the upper flow path 145 to the first outdoor condensing tube 161. The liquid-phase working fluid that flows down from the indoor condenser 18 flows into the lower flow path 144 of the evaporator 14. The flow of the working fluid in the evaporator 14 is the same as in the eleventh embodiment, and the flow of the working fluid from the outdoor condenser 16 to the indoor condenser 18 is the same as in the tenth embodiment.

Aside from the above described aspects, this embodiment is the same as the tenth embodiment or the eleventh embodiment. In the present embodiment, the same effects as those of the tenth or eleventh embodiment can be obtained as in the case of the embodiment having the common configuration.

### Thirteenth Embodiment

A thirteenth embodiment is described. The present embodiment will be explained primarily with respect to portions different from those of the eighth embodiment.

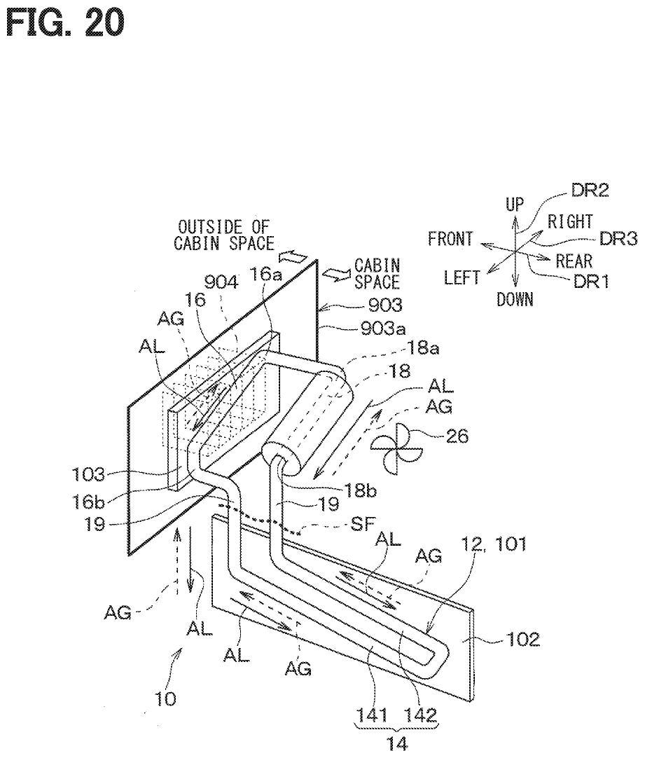

As shown in FIG. 20, the sealed container 101 of the present embodiment is configured by a loop-shaped tubular member 12. The present embodiment is different from the eighth embodiment in this point.

Specifically, in the present embodiment, the lower end of the first evaporating tube 141 and the lower end of the second evaporating tube 142 are connected to each other. The upper end 16a of the outdoor condenser 16 and the upper end 18a of the indoor condenser 18 are connected to each other. Thereby, the tubular member 12 is formed in a loop shape.

Further, the indoor condenser 18 is supported in an inclined posture similarly to the outdoor condenser 16, and is not included in the upper and lower pipe 19. The indoor condenser 18 is positioned at the same height as the outdoor condenser 16 in the up-down direction DR2.

With such a configuration, according to the present embodiment, it is possible to reduce the overall height of the cooling device 10 in the up-down direction DR2 as compared with a case where the plural condensers are arranged in the up-down direction DR2.

Aside from the above described aspects, the present embodiment is the same as the eighth embodiment. Further, in the present embodiment, effects similar to those of the eighth embodiment described above can be obtained in the same manner as in the eighth embodiment.

### Fourteenth Embodiment

A fourteenth embodiment is described. The present embodiment will be explained mainly with respect to portions different from those of the thirteenth embodiment.

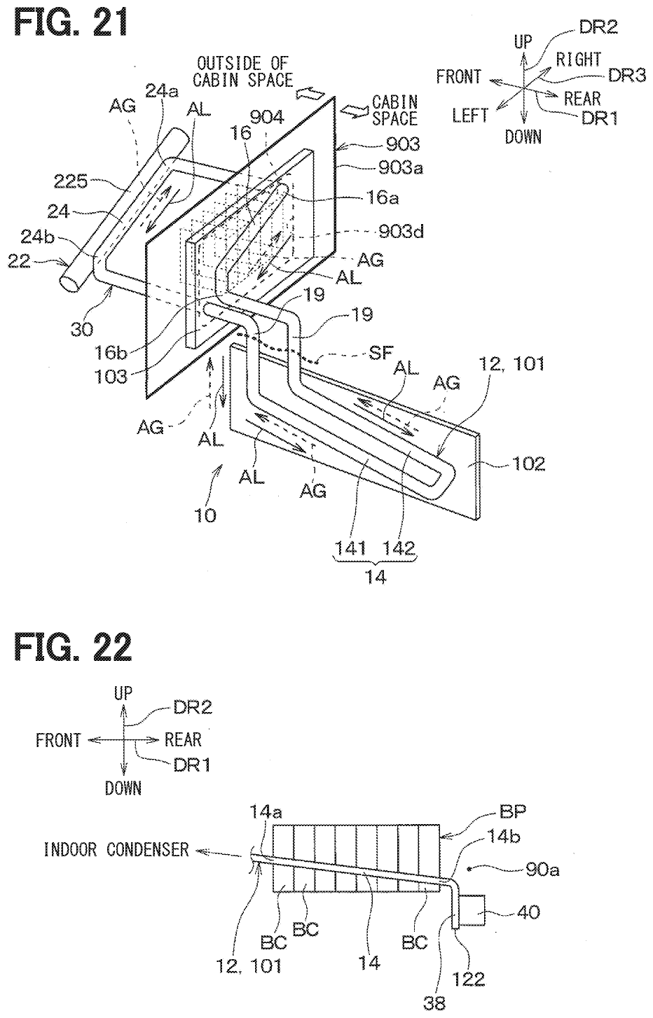

As shown in FIG. 21, the loop-shaped tubular member 12 of the sealed container 101 of the present embodiment has a refrigerant pipe condenser 24 instead of the indoor condenser 18. The present embodiment is different from the thirteenth embodiment in this point. The method of fixing the outdoor condensing fin 904 and the condensation heat diffusion plate 103 to the body panel 903a is the same as in the second embodiment shown in FIG. 7.

Specifically, in the present embodiment, the lower end of the first evaporating tube 141 and the lower end of the second evaporating tube 142 are connected to each other. The upper end 24a of the refrigerant pipe condenser 24 and the upper end 16a of the outdoor condenser 16 are connected to each other. Thereby, the tubular member 12 is formed in a loop shape.

The refrigerant pipe condenser 24 of the present embodiment is the same as the refrigerant pipe condenser 24 of the fourth to sixth embodiments. Therefore, the refrigerant pipe condenser 24 of the present embodiment is fixed to the predetermined heat absorbing portion 225 of the refrigeration cycle circuit 22 by, for example, clipping. The refrigerant pipe condenser 24 radiates heat of the working fluid vaporized in the first evaporating tube 141 to the refrigerant flowing in the predetermined heat absorbing portion 225. The predetermined heat absorbing portion 225 of this embodiment is a part of a piping member that connects the evaporator 201 and the suction port 221b of the compressor 221 in the refrigeration cycle circuit 22 of FIG. 9.

As shown in FIG. 21, the refrigerant pipe condenser 24 is disposed outside the cabin space 90a. That is, the refrigerant pipe condenser 24 is included in the outdoor arrangement part 30. The outdoor arrangement part 30 is arranged outside the cabin space 90a in a state where the outdoor arrangement part 30 is protruded out of the cabin space 90a through the body through-hole 903d. Further, the body through-hole 903d is formed in a size that allows the outdoor arrangement part 30 to pass through the inside of the body through-hole 903d.

Further, the refrigerant pipe condenser 24 is supported in an inclined posture like the outdoor condenser 16. The refrigerant pipe condenser 24 is disposed at a height substantially equal to that of the outdoor condenser 16 in the up-down direction DR2.

In the loop-shaped tubular member 12, the outdoor condenser 16 is disposed above the second evaporating tube 142, and the lower end 16b of the outdoor condenser 16 is connected to the upper end of the second evaporating tube 142. Accordingly, the gas-phase working fluid evaporated in the second evaporating tube 142 rises and flows to the outdoor condenser 16. Then, the liquid-phase working fluid condensed in the outdoor condenser 16 flows down to the second evaporating tube 142.

Further, the refrigerant pipe condenser 24 is disposed above the first evaporating tube 141, and the lower end 24b of the refrigerant pipe condenser 24 is connected to the upper end of the first evaporating tube 141. Accordingly, the gas-phase working fluid evaporated in the first evaporating tube 141 rises and flows to the refrigerant pipe condenser 24. The liquid-phase working fluid condensed in the refrigerant pipe condenser 24 flows down to the first evaporating tube 141.

Aside from the above described aspects, the present embodiment is the same as the thirteenth embodiment. Further, in the present embodiment, the same effects as the thirteenth embodiment described above can be obtained in the same manner as in the thirteenth embodiment.

### Fifteenth Embodiment

A fifteenth embodiment is described. The present embodiment will be explained mainly with respect to portions different from those of the first embodiment.

As shown in FIG. 22, the cooling device 10 of the present embodiment has a function of warming up the battery pack BP in addition to a function of cooling the battery pack BP. Specifically, the cooling device 10 includes a heating heat exchanger 38 that forms a part of the tubular member 12, and a heating device 40 that is connected to the heating heat exchanger 38 so as to be able to conduct heat. The present embodiment is different from the first embodiment in this point. The heating heat exchanger 38 and the heating device 40 are arranged, for example, in the cabin space 90a.

Specifically, the heating heat exchanger 38 is disposed below the evaporator 14. Further, the tube end 122 of the tubular member 12 is a lower end of the heating heat exchanger 38, and the heating heat exchanger 38 is connected to the lower end 14b of the evaporator 14. That is, the heating heat exchanger 38 is connected in series to the evaporator 14. Therefore, the working fluid in the liquid phase exists in the heating heat exchanger 38 both when the thermosiphon is operating and when the thermosiphon is not operating.

Further, the heating device 40 is an electric heater in which the operation and non-operation of the heating device 40 are appropriately switched according to the temperature of the battery pack BP. For example, when the temperature of the battery pack BP is lower than a predetermined temperature threshold, an electronic control unit or the like determines that warm-up is necessary, and activates the heating device 40 to generate heat.

When the heating device 40 generates heat, the working fluid in the liquid phase in the heating heat exchanger 38 is evaporated by the heating device 40 and flows into the evaporator 14 as bubbles. Then, the battery pack BP is heated and warmed up by the gas-phase, for example, bubble working fluid in the evaporator 14. At the same time, the gas-phase working fluid is condensed, and the liquid-phase working fluid returns from the evaporator 14 to the heating heat exchanger 38. In this manner, the battery pack BP is warmed up.

Aside from the above described aspects, the present embodiment is the same as the first embodiment. Further, in the present embodiment, the same effects as the first embodiment described above can be obtained in the same manner as in the first embodiment. The present embodiment is a modification of the first embodiment and can also be combined with any of the second to the fourteenth embodiments.

### Sixteenth Embodiment

A sixteenth embodiment is described. The present embodiment will be explained primarily with respect to portions different from those of the second embodiment.

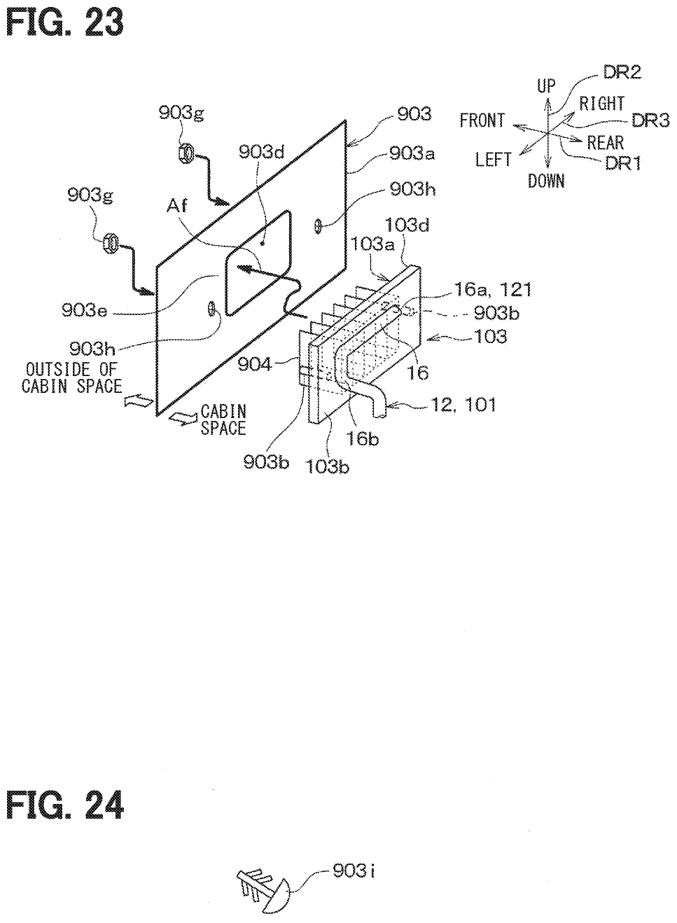

In the second embodiment, as shown in FIG. 7, the bolt 903b is fixed to the body panel 903a. In the present embodiment, as shown in FIG. 23, the bolt 903b is fixed to the condensation heat diffusion plate 103.

Specifically, as shown in FIG. 23, the condensation heat diffusion plate 103 is fixed in a state of being pressed against the body panel 903a by a nut. In this respect, the present embodiment is similar to the second embodiment.

However, unlike the second embodiment, the bolt 903b of the present embodiment is provided so as to protrude from the condensation heat diffusion plate 103 toward the body panel 903a, and is inserted through a bolt insertion hole 903h provided in the body panel 903a. A nut 903g is engaged with the bolt 903b from a side opposite to the cabin space 90a with respect to the body panel 903a (that is, from a side adjacent to the engine room 90f).

The condensation heat diffusion plate 103 is fixed to the body panel 903a by fastening the nut 903g to the bolt 903b protruding from the condensation heat diffusion plate toward the engine room 90f, from a side adjacent to the engine room 90f.

Aside from the above described aspects, the present embodiment is the same as the second embodiment. Further, in the present embodiment, effects similar to those of the second embodiment described above can be obtained in the same manner as in the second embodiment.

### Seventeenth Embodiment

A seventeenth embodiment is described. The present embodiment will be explained mainly with respect to portions different from those of the sixteenth embodiment.

In the present embodiment, the condensation heat diffusion plate 103 is fixed to the body panel 903a by clipping, not by the nut. For the clipping, for example, plural resin clips 903i are used, one of which is shown in FIG. 24. Note that, in the present embodiment, since the nut structure is not employed, the bolt 903b and the nut 903g in FIG. 23 are unnecessary. That is, the resin clip 903i in FIG. 24 replaces the bolt 903b and the nut 903g.

Specifically, in the present embodiment, the axis of the resin clip 903i is inserted into the hole provided in the condensation heat diffusion plate 103 and the hole provided in the body panel 903a from a side of the cabin space 90a toward the engine room 90f. Then, the condensation heat diffusion plate 103 is fixed to the body panel 903a in a state where the axis of the resin clip 903i is inserted in the hole of the condensation heat diffusion plate 103 and the hole of the body panel 903a.

Aside from the above described aspects, the present embodiment is the same as the sixteenth embodiment. Further, in the present embodiment, the same effects as the sixteenth embodiment described above can be obtained in the same manner as in the sixteenth embodiment.

### Eighteenth Embodiment

An eighteenth embodiment is described. The present embodiment will be explained mainly with respect to portions different from those of the first embodiment.

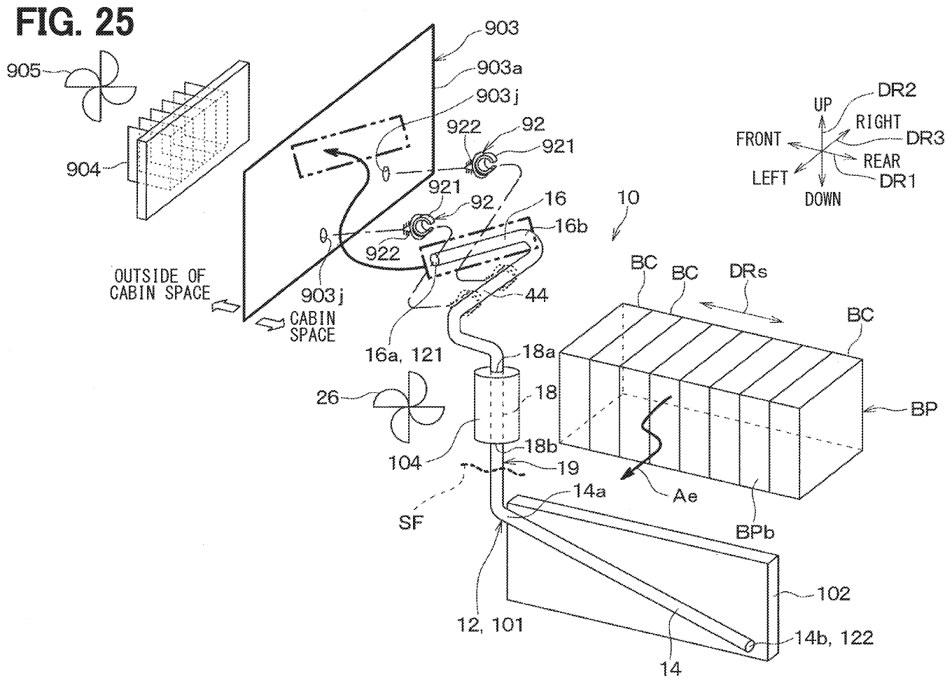

As shown in FIG. 25, in the present embodiment, the outdoor condenser 16 is fixed to the body panel 903a by clipping. In addition, the condensation heat diffusion plate 103 is not provided, and the outdoor condenser 16 is in direct contact with the body panel 903a via a heat conductive sheet material or grease. The present embodiment differs from the first embodiment in these points. In short, in the present embodiment, the outdoor condenser 16 can conduct heat to the body panel 903a similarly to the first embodiment, but the fixing method of the outdoor condenser 16 is different from the first embodiment.

The outdoor condensing fin 904 is fixed to the body panel 903a in the present embodiment as in the first embodiment. FIG. 25 is easy to show an exploded view in which the outdoor condensing fin 904 is separated from the body panel 903a.

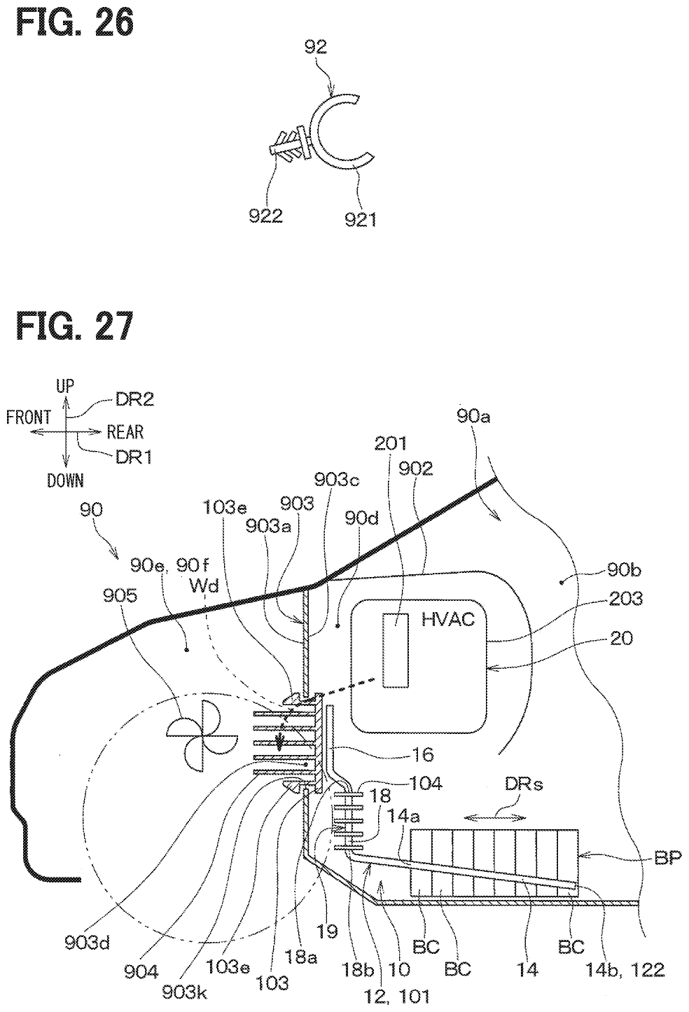

Specifically, the sealed container 101 of the present embodiment has a clip holding portion 44 located between the outdoor condenser 16 and the indoor condenser 18 to constitute a part of the tubular member 12. Further, as shown in FIGS. 25 and 26, the cooling device 10 has plural fixing clips 92. Since the fixing clip 92 replaces the bolt 903b and the nut 903g in FIG. 3, the bolt 903b and the nut 903g are not provided in the present embodiment.

As shown in FIGS. 25 and 26, the fixing clip 92 is made of, for example, an elastic resin and has a holding portion 921 and a shaft portion 922. The clip holding portion 44 of the sealed container 101 is fitted into the holding portion 921, whereby the fixing clip 92 is fixed to the clip holding portion 44.

Further, the body panel 903a has plural clip locking holes 903j, which are through-holes. The shaft portion 922 is inserted into each of the clip locking holes 903j from a side of the cabin space 90a with respect to the body panel 903a. The shaft portion 922 has a retaining structure. Due to the retaining structure, the fixing clip 92 is fixed to the body panel 903a in a state where the shaft portion 922 is inserted into the clip locking hole 903j.

Since the fixing clip 92 is fixed to the body panel 903a in this manner, the clip holding portion 44 is fixed to the body panel 903a via the fixing clip 92. Since the clip holding portion 44 and the outdoor condenser 16 are included in one tubular member 12, the rigidity of the tubular member 12 causes the outdoor condenser 16 to be fixed while being pressed against the body panel 903a.

Aside from the above described aspects, the present embodiment is the same as the first embodiment. Further, in the present embodiment, the same effects as the first embodiment described above can be obtained in the same manner as in the first embodiment.

### Nineteenth Embodiment

A nineteenth embodiment is described. The present embodiment will be explained primarily with respect to portions different from those of the second embodiment.

As shown in FIG. 27, the present embodiment is the same as the second embodiment in that the outdoor condenser 16 is fixed to the body panel 903a via the condensation heat diffusion plate 103. However, in the present embodiment, the method of fixing the condensation heat diffusion plate 103 to the body panel 903a is different from the second embodiment.

Specifically, the condensation heat diffusion plate 103 of the present embodiment has plural locking claws 103e disposed on both sides of the outdoor condensing fin 904. The locking claw 103e replaces the bolt 903b and the nut 903g in FIG. 7, and therefore, in this embodiment, the bolt 903b and the nut 903g are not provided.

As shown in FIG. 27, each of the locking claws 103e is provided so as to protrude toward the engine room 90f. Each of the locking claws 103e is engaged with a hole peripheral portion 903k of the body panel 903a around the body through-hole 903d. As a result, the condensation heat diffusion plate 103 is fixed to the body panel 903a. A gap between the condensation heat diffusion plate 103 and the body panel 903a is sealed by a grommet (not shown) over the entire circumference of the condensation heat diffusion plate 103.

Aside from the above described aspects, the present embodiment is the same as the second embodiment. Further, in the present embodiment, effects similar to those of the second embodiment described above can be obtained in the same manner as in the second embodiment.

### Twentieth Embodiment

A twentieth embodiment is described. The present embodiment will be explained mainly with respect to portions different from those of the first embodiment.

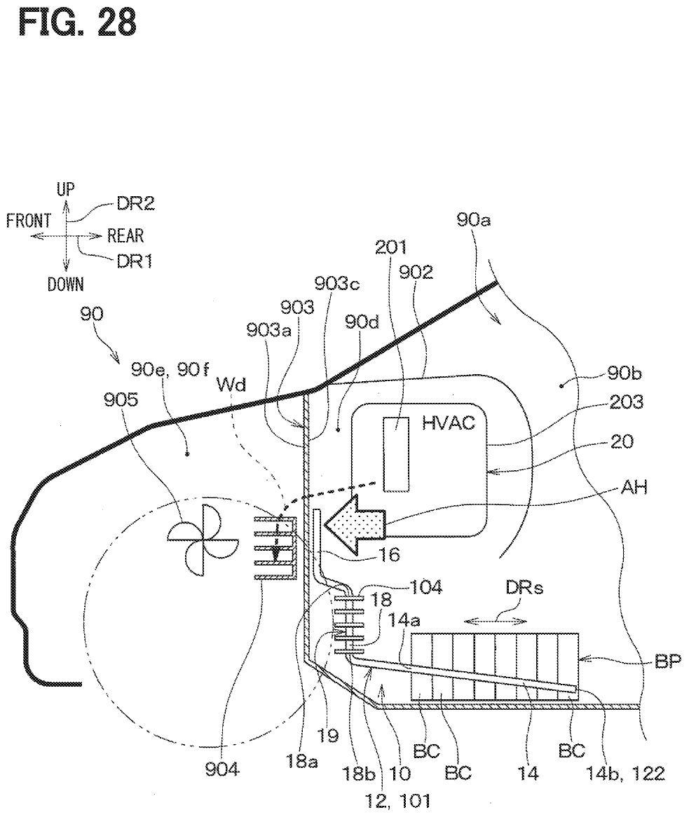

As illustrated in FIG. 28, the cooling device 10 of the present embodiment does not include the condensation heat diffusion plate 103 while the cooling device 10 may include the condensation heat diffusion plate 103. The outdoor condenser 16 is in direct contact with the body panel 903a via a heat conductive sheet material or grease.

Further, the outdoor condenser 16 of the present embodiment is fixed to the air conditioning case 203 by, for example, clipping or snap-fit, and is arranged so as to be held between the air conditioning case 203 and the body panel 903a. The air conditioning case 203 is fixed to the vehicle body 903, and in this fixed state, the outdoor condenser 16 is pressed against the body panel 903a as indicated by an arrow AH. The outdoor condenser 16 is fixed to the body panel 903a while being pressed against the body panel 903a.

Since the outdoor condenser 16 of the present embodiment is fixed to the body panel 903a as described above, a nut is not used for the fixing. Therefore, the bolt 903b and the nut 903g of FIG. 3 are not provided in the present embodiment.

Aside from the above described aspects, the present embodiment is the same as the first embodiment. Further, in the present embodiment, the same effects as the first embodiment described above can be obtained in the same manner as in the first embodiment.

### Twenty-First Embodiment

A twenty-first embodiment is described. The present embodiment will be explained mainly with respect to portions different from those of the twentieth embodiment.

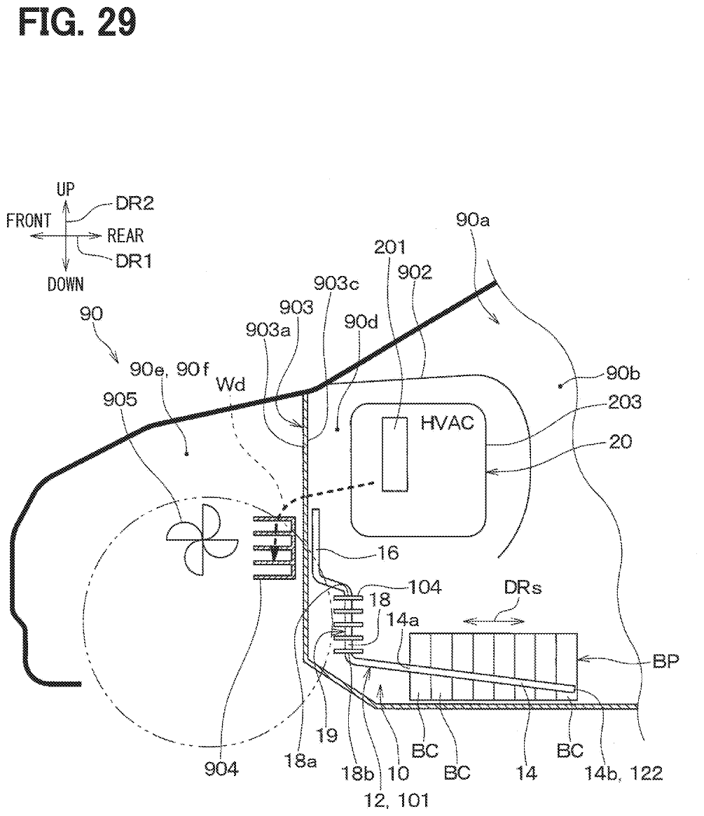

As shown in FIG. 29, in the present embodiment, similarly to the twentieth embodiment, the outdoor condenser 16 is fixed to the body panel 903a while being pressed against the body panel 903a. However, the outdoor condenser 16 is not fixed to the air conditioning case 203. The method of pressing the outdoor condenser 16 against the body panel 903a in the present embodiment is different from the twentieth embodiment.

Specifically, in the present embodiment, the battery pack BP is firmly fixed to the vehicle body 903 by bolting or the like. The evaporator 14 of the sealed container 101 is attached and fixed to the battery pack BP. By fixing the sealed container 101 to the battery pack BP, the whole of the sealed container 101 is held. When the sealed container 101 is fixed to the battery pack BP, the outdoor condenser 16 of the sealed container 101 is pressed against the body panel 903a and is fixed to the body panel 903a.

Aside from the above described aspects, the present embodiment is the same as the twentieth embodiment. Further, in the present embodiment, the same effects as the twentieth embodiment described above can be obtained in the same manner as in the twentieth embodiment.

### Twenty-Second Embodiment

A twenty-second embodiment is described. The present embodiment will be explained primarily with respect to portions different from those of the second embodiment.

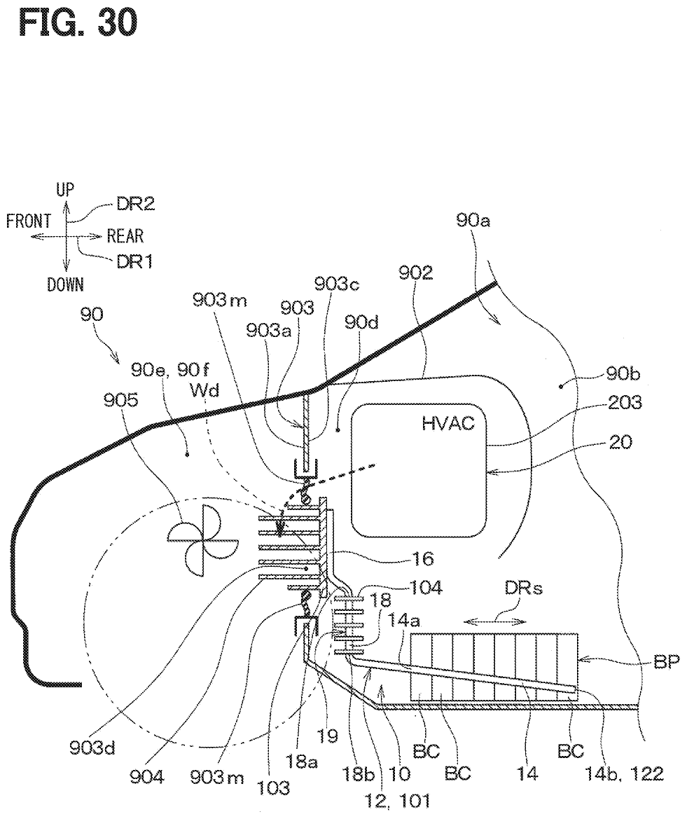

As shown in FIG. 30, in the present embodiment, the battery pack BP is firmly fixed to the vehicle body 903 by bolting or the like. The evaporator 14 of the sealed container 101 is attached and fixed to the battery pack BP. The whole of the sealed container 101 is held by fixing the sealed container 101 to the battery pack BP.

That is, in the present embodiment, the outdoor condenser 16 is not fixed to the body panel 903a. Instead, the outdoor condenser 16 is fixed to the battery pack BP. The battery pack BP is a member provided in the cabin space 90a, similarly to the second embodiment. Furthermore, in view of the positional relationship between the battery pack BP and the vehicle body 903, the battery pack BP is also a member provided adjacent to the cabin space 90a with respect to the vehicle body 903 around the cabin space 90a.

The space between the condensation heat diffusion plate 103 and the body panel 903a is sealed by a grommet 903m all around the condensation heat diffusion plate 103.

In this embodiment, since the outdoor condenser 16 is not fixed to the body panel 903a as described above, the bolt 903b and the nut 903g of FIG. 7 are not provided.

Aside from the above described aspects, the present embodiment is the same as the second embodiment. Further, in the present embodiment, effects similar to those of the second embodiment described above can be obtained in the same manner as in the second embodiment.

### Twenty-Third Embodiment

A twenty-third embodiment is described. The present embodiment will be explained mainly with respect to portions different from those of the first embodiment.

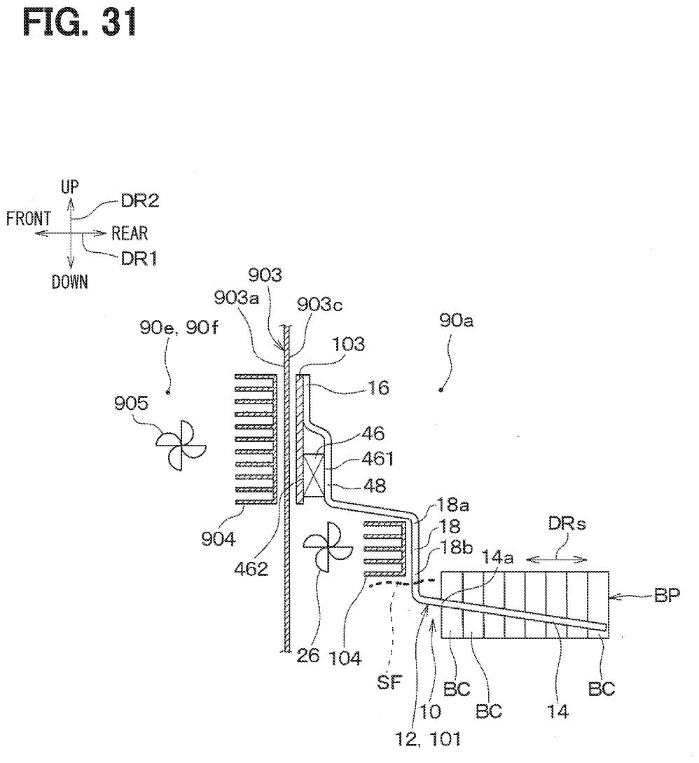

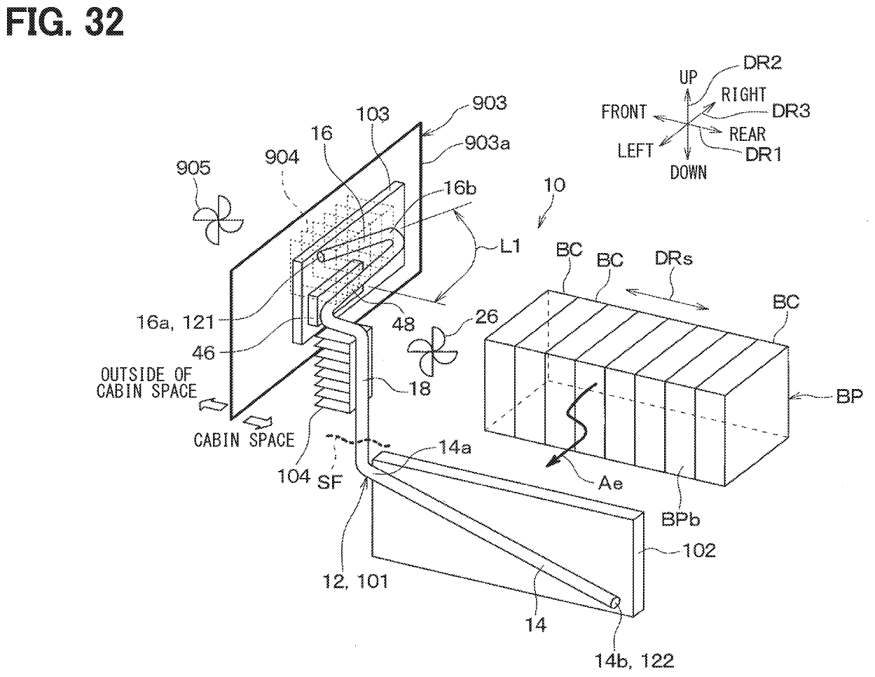

As shown in FIGS. 31 and 32, the cooling device 10 includes a Peltier element 46. That is, the cooling device 10 is capable of dissipating heat from the working fluid to the outside air using the Peltier element 46, in addition to the heat dissipation from the outdoor condenser 16 and the heat dissipation from the indoor condenser 18. In this point, the present embodiment is different from the first embodiment.

Specifically, the sealed container 101 has an outdoor Peltier condenser 48 that forms a part of the tubular member 12, at a location between the outdoor condenser 16 and the indoor condenser 18. Therefore, the outdoor Peltier condenser 48 is located below the outdoor condenser 16 and above the indoor condenser 18.

The Peltier element 46 has a heat absorbing surface 461 that absorbs heat from the outside of the Peltier element 46 and a heat radiation surface 462 that releases heat to the outside of the Peltier element 46. The heat absorbing surface 461 of the Peltier element 46 is connected to the outdoor Peltier condenser 48 so as to be able to conduct heat, and the heat radiation surface 462 of the Peltier element 46 is connected to the condensation heat diffusion plate 103 so as to be able to conduct heat.

Therefore, when the Peltier element 46 is energized, the Peltier element 46 absorbs heat from the working fluid in the outdoor Peltier condenser 48 via the heat absorbing surface 461, and at the same time, radiates heat from the heat radiation surface 462. The heat radiated from the Peltier element 46 is sequentially conducted to the condensation heat diffusion plate 103, the body panel 903a, and the outdoor condensing fin 904, and is radiated from the outdoor condensing fin 904 to the outside air. Accordingly, the working fluid in the outdoor Peltier condenser 48 is cooled by the Peltier element 46, so that the working fluid is condensed.

The outdoor condensing fin 904 is provided in the engine room 90f so as to be exposed to the outside air and fixed to the body panel 903a so as to be able to conduct heat, similarly to the first embodiment. However, the outdoor condensing fin 904 of this embodiment is provided so as to overlap both the outdoor condenser 16 and the heat radiation surface 462 of the Peltier element 46 in the thickness direction of the body panel 903a on the side of the engine room 90f. Therefore, the outdoor condensing fin 904 of the present embodiment can efficiently radiate heat from both the outdoor condenser 16 and the heat radiation surface 462 of the Peltier element 46 to the outside air.

When the Peltier element 46 is not energized, the cooling device 10 of the present embodiment operates in the same manner as the cooling device 10 of the first embodiment.

When the Peltier element 46 is energized, the temperature of the outdoor Peltier condenser 48 becomes the lowest in the sealed container 101. Therefore, when the gas-phase working fluid evaporated in the evaporator 14 rises in the sealed container 101 and reaches the outdoor Peltier condenser 48, the gas-phase working fluid in the outdoor Peltier condenser 48 is condensed in the outdoor Peltier condenser 48. Then, the condensed liquid-phase working fluid flows down from the outdoor Peltier condenser 48 to the evaporator 14 by the action of gravity. At this time, since the outdoor condenser 16 has a higher temperature than the outdoor Peltier condenser 48, the gas-phase working fluid does not rise from the outdoor Peltier condenser 48 to the outdoor condenser 16. In the outdoor condenser 16, the gas-phase working fluid remains stagnant.

It is preferable that a distance L1 (see FIG. 32) between the outdoor condenser 16 and the outdoor Peltier condenser 48 along the tubular member 12 is not less than a predetermined length to suppress the heat conduction between the outdoor condenser 16 and the outdoor Peltier condenser 48. This is to restrict heat transmitted from the Peltier element 46 to the outdoor condensing fin 904, when the Peltier element 46 is energized, from returning to the outdoor Peltier condenser 48 from the outdoor condensing fin 904 via the outdoor condenser 16.

According to the present embodiment, the Peltier element 46 is provided as described above. Therefore, when the temperatures of the outside air and the inside air are so high that the heat cannot be dissipated from the outdoor condenser 16 and the indoor condenser 18, the heat is radiated from the working fluid to the outside air by using the Peltier element 46, whereby the working fluid is condensed. If heat can be released from either the outdoor condenser 16 or the indoor condenser 18, the working fluid can be condensed without energizing the Peltier element 46.

Therefore, the cooling device 10 can efficiently cool the battery pack BP by appropriately switching between energization and non-energization of the Peltier element 46.

Aside from the above described aspects, the present embodiment is the same as the first embodiment. Further, in the present embodiment, the same effects as the first embodiment described above can be obtained in the same manner as in the first embodiment.

### Twenty-Fourth Embodiment

A twenty-fourth embodiment is described. The present embodiment will be explained mainly with respect to portions different from those of the first embodiment.

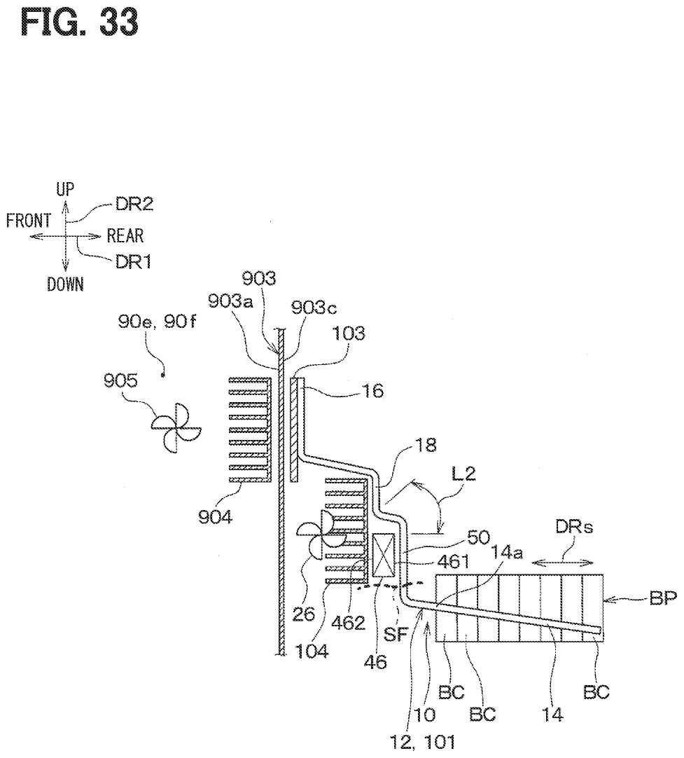

As shown in FIG. 33, the cooling device 10 includes a Peltier element 46. That is, the cooling device 10 is capable of dissipating heat from the working fluid to the inside air using the Peltier element 46, in addition to the heat dissipation from the outdoor condenser 16 and the heat dissipation from the indoor condenser 18. In this point, the present embodiment is different from the first embodiment. Note that the Peltier element 46 of the present embodiment is similar to the Peltier element 46 of the twenty-third embodiment, but the arrangement is different from that of the twenty-third embodiment.

Specifically, the sealed container 101 has an indoor Peltier condenser 50 that forms a part of the tubular member 12 at a location between the indoor condenser 18 and the evaporator 14. Therefore, the indoor Peltier condenser 50 is located below the indoor condenser 18 and above the evaporator 14.

The heat absorbing surface 461 of the Peltier element 46 is connected to the indoor Peltier condenser 50 so as to be able to conduct heat, and the heat radiation surface 462 of the Peltier element 46 is connected to the indoor fin 104 so as to be able to conduct heat.

Therefore, when the Peltier element 46 is energized, the Peltier element 46 absorbs heat from the working fluid in the indoor Peltier condenser 50 via the heat absorbing surface 461, and at the same time, radiates heat from the heat radiation surface 462. The heat radiated from the Peltier element 46 is conducted to the indoor fin 104 and is radiated from the indoor fin 104 to the inside air. Accordingly, the working fluid in the indoor Peltier condenser 50 is cooled by the Peltier element 46, so that the working fluid is condensed.

The indoor fin 104 is connected to both the heat radiation surface 462 of the Peltier element 46 and the indoor condenser 18 so as to be able to conduct heat. As a result, the indoor fin 104 facilitates heat radiation from the working fluid in the indoor condenser 18 to the inside air and heat radiation from the Peltier element 46 to the inside air, respectively.

When the Peltier element 46 is not energized, the cooling device 10 of the present embodiment operates in the same manner as the cooling device 10 of the first embodiment.

When the Peltier element 46 is energized, the temperature of the indoor Peltier condenser 50 becomes the lowest in the sealed container 101. Accordingly, when the gas-phase working fluid evaporated in the evaporator 14 rises in the sealed container 101 and reaches the indoor Peltier condenser 50, the gas-phase working fluid in the indoor Peltier condenser 50 is condensed in the indoor Peltier condenser 50. Then, the condensed liquid-phase working fluid flows down from the indoor Peltier condenser 50 to the evaporator 14 by the action of gravity.

At this time, since the outdoor condenser 16 and the indoor condenser 18 have a higher temperature than the indoor Peltier condenser 50, the working fluid in the gas phase does not rise from the indoor Peltier condenser 50 to the indoor condenser 18. Therefore, the gas-phase working fluid remains stagnant in a portion of the sealed container 101 above the indoor Peltier condenser 50. For example, the gas-phase working fluid remains stagnant in the outdoor condenser 16 and the indoor condenser 18 which are included in the portion above the indoor Peltier condenser 50.

It is preferable that a distance L2 between the indoor condenser 18 and the indoor Peltier condenser 50 along the tubular member 12 is not less than a predetermined length to suppress heat conduction between the indoor condenser 18 and the indoor Peltier condenser 50. This is to restrict the heat transmitted from the Peltier element 46 to the indoor fin 104, when the Peltier element 46 is energized, from returning to the indoor Peltier condenser 50 from the indoor fin 104 via the indoor condenser 18.

According to the present embodiment, the Peltier element 46 is provided as described above. Therefore, similarly to the twenty-third embodiment, the cooling device 10 can efficiently cool the battery pack BP by appropriately switching between energization and non-energization of the Peltier element 46.

Aside from the above described aspects, the present embodiment is the same as the first embodiment. Further, in the present embodiment, the same effects as the first embodiment described above can be obtained in the same manner as in the first embodiment.

### Other Embodiments

(1) In the first embodiment, as shown in FIG. 3, the evaporator 14, the outdoor condenser 16, and the indoor condenser 18 are each configured as a part of the tubular member 12. However, one of the evaporator 14, the outdoor condenser 16, and the indoor condenser 18 may be constituted by a member different from the tubular member 12.

(2) In FIGS. 1 and 2 of the first embodiment described above, the battery pack BP and the evaporator 14 are arranged below the seat 901, but may be arranged in another place such as a space in the center console or luggage room.

(3) In each of the embodiments, as shown in FIG. 2 and the like, the body panel 903a to which the outdoor condenser 16 is attached has a vertical wall shape extending in the up-down direction DR2. There is no limitation on the orientation or posture of the body panel 903a to which the outdoor condenser 16 is attached.

(4) In each of the embodiments, as shown in FIG. 2 and the like, the outdoor condenser 16 is arranged to radiate heat to the outside air in the engine room 90f. Alternatively, the outdoor condenser 16 may be arranged to radiate heat to outside air in a space located outside the engine room 90f. For example, when the outdoor condenser 16 is arranged in the luggage room, heat is radiated to outside air in a space near the rear wheel out of the cabin space 90a. In other words, the body panel 903a to which the outdoor condenser 16 is attached has various arrangement locations.

(5) In each of the embodiments, the indoor condenser 18 does not have a flat cross-sectional shape extending in the up-down direction DR2, but is not limited thereto. That is, the indoor condenser 18 may have the same flat cross-sectional shape as the outdoor condenser 16 shown in FIG. 4 while being disposed so as to extend obliquely, for example, like the outdoor condenser 16 of FIG. 5.

Further, a mere intermediate part of the tubular members 12 not intended for heat exchange may have a flat cross-sectional shape extending in the up-down direction DR2. In this case, gas-liquid separation becomes easier in the intermediate part between gas-phase working fluid upward and liquid-phase working fluid downward, so that the flow of the working fluid is improved in the intermediate part.

(6) In each of the embodiments, as shown in FIG. 4, each of the evaporator 14 and the outdoor condenser 16 has a flat cross-sectional shape extending in the up-down direction DR2, but this is an example. For example, one or both of the evaporator 14 and the outdoor condenser 16 may have a cross-sectional shape other than the flat cross-sectional shape, such as a rectangular cross-sectional shape or a circular cross-sectional shape.

(7) In each of the embodiments, as shown in FIG. 4, an internal fin is not provided in the evaporator 14 and the outdoor condenser 16, but an internal fin may be provided in the evaporator 14 and the outdoor condenser 16. If the internal fin is provided, an improvement in heat exchange performance can be expected. That is, evaporation of the working fluid in the thermosiphon becomes active, and the cooling capacity of the cooling device 10 is improved.

(8) In FIG. 2 illustrated for the first embodiment, the upper and lower pipe 19 extends in parallel with the up-down direction DR2, but may be slightly inclined with respect to the up-down direction DR2, while the upper and lower pipe 19 is arranged so as to extend in the up-down direction DR2.

(9) In the first embodiment, the outdoor condensing fin 904 is provided as shown in FIGS. 2 and 3, but the outdoor condensing fin 904 may be omitted. Because the vehicle body 903 is exposed to the outside air, the vehicle body 903 can transfer heat to the outside air without the outdoor condensing fin 904.

(10) In each of the embodiments, the guide 191 provided in the indoor condenser 18 of FIG. 6 is a part separate from the tubular member 12, but the guide 191 may be formed as a part of the tubular member 12. Further, the guide 191 may be not provided.

(11) In each of the embodiments, the guide 191 provided in the indoor condenser 18 in FIG. 6 is an internal fin, but this is an example. For example, instead of the internal fin of FIG. 6, a spirally extending groove is provided on the inner wall 192 of the upper and lower pipe 19, to function as the guide 191 for guiding a liquid-phase working fluid.

(12) In the first embodiment, as shown in FIG. 3, the respective tube ends 121 and 122 of the tubular member 12 are tightly closed by brazing or sealing plugs, but this is an example. For example, one or both of the tube ends 121 and 122 may be provided with a tube end installation component instead of the brazing or sealing plug. The tube end installation component is, for example, a relief valve, a charge valve for charging the working fluid into the sealed container 101, a physical quantity sensor for detecting a physical quantity (for example, temperature or pressure) of the working fluid in the sealed container 101, and the like.

Further, each of the tube ends 121 and 122 of the tubular member 12 is disposed in the cabin space 90a, but this is an example. For example, a through-hole is provided in the vehicle body 903, and one or both of the tube ends 121 and 122 are led out of the cabin space 90a through the through-hole to be located outside the cabin space 90a.

(13) In the fourth embodiment, as shown in FIG. 9, the predetermined heat absorbing portion 225 to which the refrigerant pipe condenser 24 is fixed is a part of a piping member connecting the suction port 221b of the compressor 221 to the evaporator 201 in the refrigeration cycle circuit 22, but this is an example. For example, the predetermined heat absorbing portion 225 may be a part of the evaporator 201. In short, the predetermined heat absorbing portion 225 only needs to form a part of the low-pressure refrigerant flow path in the refrigeration cycle circuit 22 until the refrigerant flowing out of the expansion valve 223 is drawn into the compressor 221. This is because the low-pressure low-temperature refrigerant depressurized by the expansion valve 223 flows through the low-pressure refrigerant flow path.

(14) In each of the embodiments, the heat radiation object for condensing the working fluid is the outside air, the inside air, the drain water Wd of the air conditioning unit 20, or the low-pressure low-temperature refrigerant flowing through the refrigeration cycle circuit 22, in the cooling device 10, but these are examples. For example, the heat radiation object for condensing the working fluid may be cooling water, cold air blown from the air conditioning unit 20, or a Peltier element. The heat radiation object may be replaced with or together with the drain water Wd, which is another heat radiation object different from the outside air that receives heat from the working fluid in the outdoor condenser 16.

Further, as described above, there are plural heat radiating objects for condensing the working fluid. For example, the cooling device 10 may include a condensation adjusting device configured to control the heat absorbing ability to condense the working fluid by absorbing heat for each of the heat radiating object. For example, the condensation adjusting device does not need to be provided for all the heat radiation objects, but may be provided only for any one of the heat radiation objects.

The condensation adjusting device provided in such a manner adjusts the heat absorbing capacity of the heat radiating object according to, for example, the temperature of the battery pack BP and the temperature of the heat radiating object. Specifically, in order to adjust the heat absorbing ability, the amount of air blown from outside air or inside air is controlled, and/or the amount of air blown by a blower switching door is controlled. Further, in order to adjust the heat absorption capacity, the cooling capacity by the air conditioning unit 20, the discharge amount of the cooling water pump, the air flow rate of the cooling radiator fan, the air flow rate of the Peltier element, and/or the Peltier cooling power is controlled.

(15) In the eighth embodiment, as shown in FIG. 14, the heat radiation object of the outdoor condenser 16 is outside air, and the heat radiation object of the indoor condenser 18 is inside air. However, the heat radiation objects may be the same.

(16) In the eighth embodiment, as shown in FIG. 14, the cooling device 10 has two tubular members 12, but this is an example. For example, in place of the two tubular members 12, the cooling device 10 has a single U-shape tubular member 12 in which the lower end of the first evaporating tube 141 and the lower end of the second evaporating tube 142 in FIG. 14 are connected with each other.

(17) In each of the embodiments, as shown in FIG. 2 and the like, the outdoor condenser 16 is disposed in the cabin space 90a, but may be disposed in a space other than the cabin space 90a. For example, a condenser cover that can be easily removed by working in the cabin space 90a is attached around the outdoor condenser 16, and the arrangement space of the outdoor condenser 16 is separated from the cabin space 90a by the condenser cover. This is because the outdoor condenser 16 can be attached to and detached from the side adjacent to the vehicle body 903 with respect to the vehicle body 903 even in such a case.

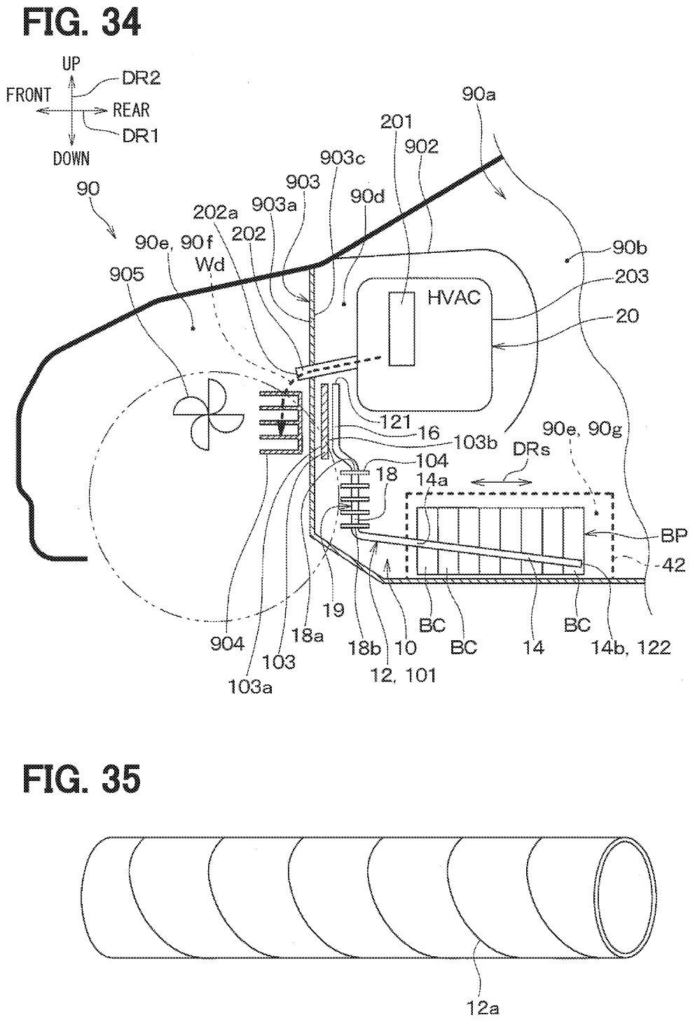

(18) In each of the embodiments, as shown in FIGS. 1 and 2, the battery pack BP, the evaporation heat diffusion plate 102, and the evaporator 14 are arranged in the cabin space 90a, but may be arranged in a space other than the cabin space 90a. For example, as shown in FIG. 34, the battery pack BP, the evaporation heat diffusion plate 102, and the evaporator 14 may be arranged in a battery space 90g separated from the cabin space 90a by the battery cover 42. Since the battery cover 42 is removable, the battery cover 42 is provided as a partition member that can be opened to the cabin space 90a.

Further, the battery space 90g is separated from the cabin space 90a by the battery cover 42, the flow of air is blocked by to the seat space 90b. Therefore, the battery space 90g corresponds to the non-communication space 90e in which the flow of air to the seat space 90b is blocked.

If the battery cover 42 has a penetrating portion where the tubular member 12 penetrates the battery cover 42, a gap between the tubular member 12 and the battery cover 42 in the penetrating portion is sealed by, for example, a seal grommet.

Since the battery space 90g in FIG. 34 is not included in the cabin space 90a, the battery pack BP arranged in the battery space 90g is not a member provided in the cabin space 90a. However, the battery pack BP is a member provided adjacent to the cabin space 90a with respect to the vehicle body 903 around the cabin space 90a due to the positional relationship between the vehicle body 903, the battery space 90g, and the cabin space 90a.

(19) In the fifth embodiment, the vehicle body 903 has the body through-hole 903f large enough to allow the outdoor arrangement part 30 to pass through, but is not necessary to be directly formed in the vehicle body 903. The body through-hole 903f may be a through-hole provided for the vehicle body 903. The through-hole provided for the vehicle body 903 includes not only a through-hole formed directly on the vehicle body 903 but also a through-hole formed indirectly on the vehicle body 903. The through-hole indirectly formed in the vehicle body 903 is, for example, a through-hole formed in a body integral part provided integrally with the vehicle body 903.

(20) In each of the embodiments, for example, as shown in FIG. 2, the target device cooled by the cooling device 10 is the battery pack BP, but this is an example. The target device is not limited to the battery pack BP, and may be, for example, an electronic control device or an electric device that generates heat.

(21) In each of the embodiments, for example, a seamless tube is adopted as the material of the tubular member 12, but the material of the tubular member 12 is not limited to this. For example, the tubular member 12 that forms the sealed container 101 may be made of a UO tube, a spiral tube, or a plate-wound tube in addition to a seamless tube. The UO tube, the spiral tube, and the plate-wound tube are all tube materials having an essential seam 12a (see FIG. 35) which is a seam necessary to be formed into a tubular shape. FIG. 35 shows a spiral tube.

(22) In the twentieth embodiment, the outdoor condenser 16 shown in FIG. 28 is fixed to the air conditioning case 203 by, for example, clipping or snap fitting, but such fixing may not be performed. For example, the outdoor condenser 16 is not fixed to the air conditioning case 203 by clipping or the like, and the outdoor condenser 16 is held to the air conditioning case 203 and the body panel 903a by being pressed between the air conditioning case 203 and the body panel 903a.

(23) In the second embodiment, as shown in FIG. 7, the outdoor condenser 16 is fixed to the body panel 903a, but need not be fixed to the body panel 903a. For example, the outdoor condenser 16 may be fixed to the instrument panel 902 or the air conditioning case 203 (see FIG. 2). The instrument panel 902 and the air conditioning case 203 are members provided in the cabin space 90a, as shown in FIG. 2. The instrument panel 902 and the air conditioning case 203 are also members provided adjacent to the cabin space 90a with respect to the vehicle body 903 around the cabin space 90a due to the positional relationship with the vehicle body 903.

(24) Note that the present disclosure is not limited to the embodiment described above, and can be variously modified. The above embodiments are not independent of each other, and can be appropriately combined together except when the combination is obviously impossible.

Further, in each of the above-mentioned embodiments, it goes without saying that components of the embodiment are not necessarily essential except for a case in which the components are particularly clearly specified as essential components, a case in which the components are clearly considered in principle as essential components, and the like. A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. Further, in each of the embodiments described above, when materials, shapes, positional relationships, and the like, of the components and the like, are mentioned, they are not limited to these materials, shapes, positional relationships, and the like, unless otherwise specified and unless limited to specific materials, shapes, positional relationships, and the like.

### (Overview)

According to the first aspect shown in a part or all of the embodiments, the outdoor condenser of the cooling device forms a part of the sealed container and is disposed above the evaporator. The outdoor condenser is disposed on the cabin space side with respect to the vehicle body around the cabin space, and is fixed to the vehicle body or a member provided on the cabin space side with respect to the vehicle body. The outdoor condenser condenses the working fluid by releasing heat of the working fluid vaporized in the evaporator to the outside air.

According to the second aspect, the outdoor condenser is fixed to the vehicle body. The outdoor condenser is capable of transferring heat to outside air by being fixed to the vehicle body, such that it is possible to radiate heat of the outdoor condenser to the outside air outside the cabin space without having to take in the outside air from the outside space separated by the vehicle body from the cabin space. Therefore, it is possible to cool the target device by radiating heat to the outside air via the outdoor condenser, and to arrange the target device on the side of the cabin space relative to the vehicle body with a simple structure.

According to the third aspect, the outdoor condenser radiates heat of the working fluid in the outdoor condenser to the outside air via the vehicle body. The outdoor condenser is fixed to a surface of the vehicle body on the side of the cabin space so that heat can be conducted to the vehicle body, whereby the outdoor condenser can conduct heat to the outside air. Therefore, it is possible to utilize the vehicle body as a part of the heat transfer path, and to arrange the outdoor condenser on the side of the cabin space with respect to the vehicle body with a simple assembling structure.

According to the fourth aspect, the vehicle includes an outdoor condensing fin that facilitates heat radiation from the working fluid in the outdoor condenser to the outside air. The outdoor condensing fin is provided outside the cabin space so as to be exposed to the outside air, and is fixed to conduct heat to the vehicle body. Therefore, it is possible to improve the condensing ability for condensing the working fluid in the outdoor condenser.

According to the fifth aspect, a cooling device includes a condensation heat diffusion plate to which the outdoor condenser is joined. The outdoor condenser is fixed to the surface of the vehicle body on the side of the cabin space via the condensation heat diffusion plate. Therefore, it is possible to easily increase the heat transfer area that contributes to the heat transfer between the outdoor condenser and the vehicle body. Then, it is easy to make the shape of the outdoor condenser simple such as a tube shape while keeping the heat transfer performance between the outdoor condenser and the vehicle body.

According to the sixth aspect, the cooling device includes an outdoor condensing fin provided outside the cabin space so as to be exposed to the outside air, to facilitate heat radiation from the working fluid in the outdoor condenser to the outside air. The vehicle body has a body through-hole that penetrates the vehicle body, and the outdoor condensing fin is fixed to the vehicle body so as to close the body through-hole from the side opposite to the cabin space. In addition, the outdoor condenser is fixed to the cabin space side of the outdoor condensing fin through the inside of the body through-hole so that heat can be conducted to the outdoor condensing fin. Therefore, it is possible to restrict water from entering the cabin space from the body through-hole together with the outdoor condensing fin, and to dispose the outdoor condenser on the cabin space side with respect to the vehicle body with a simple assembly structure.

According to the seventh aspect, the cooling device includes a condensation heat diffusion plate having one surface to which the outdoor condenser is joined. The cooling device includes an outdoor condensing fin joined to the one surface of the condensation heat diffusion plate, for facilitating heat radiation from the working fluid in the outdoor condenser to the outside air. The vehicle body has a body through-hole that penetrates the vehicle body. Further, in a state where the outdoor condensing fin is exposed to the outside of the cabin space through the body through-hole, the condensation heat diffusion plate is fixed to the vehicle body so as to cover the body through-hole from the cabin space side. Thus, the outdoor condenser can conduct heat to outside air. Therefore, the outdoor condenser can be disposed on the cabin space side with respect to the vehicle body with a simple assembly structure.

According to the eighth aspect, the one surface of the condensation heat diffusion plate has a fin peripheral portion located to surround a portion where the outdoor condensing fin is joined. The fin peripheral portion is pressed against a body hole peripheral portion that forms a periphery of the body through-hole, thereby sealing a gap between the body hole peripheral portion and the fin peripheral portion. Therefore, it is possible to restrict the infiltration of water from the body through-hole into the cabin space by the condensation heat diffusion plate.

According to the ninth aspect, the evaporator and the target device are arranged in the cabin space or in a space separated by a partition member that can be opened to the cabin space. The outdoor condenser is fixed to the vehicle body so as to be detachable from the vehicle body. Therefore, the sealed container including the outdoor condenser and the evaporator can be easily detachable from the cabin space side with respect to the vehicle body.

According to the tenth aspect, an outdoor arrangement part forms a part of the sealed container, and is arranged outside the cabin space by being extended to the outside of the cabin space through a through-hole defined in the vehicle body. The evaporator and the target device are arranged in the cabin space or in a space separated by a partition member that can be opened to the cabin space. The outdoor condenser is fixed to the vehicle body to be detachable from the vehicle body. The through-hole is formed in such a size that the outdoor arrangement part can pass through the inside of the through-hole. Therefore, when the sealed container is removed from the vehicle body, the outdoor arrangement part can be taken in from the outside of the cabin space into the cabin space through the through-hole. Therefore, it is possible to easily configure the entire sealed container including the outdoor arrangement part so that the sealed container can be removed to the cabin space side with respect to the vehicle body.

According to the eleventh aspect, the outdoor condenser is configured to radiate heat from the working fluid to a heat radiation object different from the outside air. Therefore, even in a case where heat is hardly dissipated from the outdoor condenser to the outside air due to, for example, a high-temperature outside air, the heat dissipating from the outdoor condenser can be facilitated by the other heat radiation object.

According to the twelfth aspect, the other condenser included in the cooling device forms a part of the sealed container, and is disposed above the evaporator to radiate the heat of the working fluid to a predetermined heat radiation object other than the outside air. This causes the working fluid to condense. Therefore, even when heat cannot be released from the outdoor condenser to the outside air due to, for example, a high-temperature outside air, the operation of the thermosiphon can be maintained.

According to the thirteenth aspect, the sealed container has a tubular member. At least one of the evaporator, the other condenser, and the outdoor condenser is configured as a part of the tubular member. Therefore, it is possible to establish a thermosiphon with a simple structure mainly including a tubular member.

According to the fourteenth aspect, the sealed container has a tubular member. The other condenser is an indoor condenser that condenses the working fluid by releasing heat of the working fluid to the inside air as a predetermined heat radiation object. The evaporator, the other condenser, and the outdoor condenser are each configured as a part of the tubular member, and are arranged in the order of the evaporator, the other condenser, and the outdoor condenser from the lower side. The lower end of the outdoor condenser is connected to the upper end of the other condenser, and the upper end of the evaporator is connected to the lower end of the other condenser. Therefore, the evaporator, the indoor condenser, which is the other condenser, and the outdoor condenser are connected in series in the order of the evaporator, the indoor condenser, and the outdoor condenser, and are provided on, for example, one tubular member. Also, from this arrangement order, the gas-phase working fluid evaporated in the evaporator reaches the indoor condenser before reaching the outdoor condenser. Therefore, the working fluid can be efficiently condensed by the indoor condenser when the temperature of outside air is high.

According to the fifteenth aspect, the upper and lower pipe provided in the cooling device is configured as a part of the tubular member, and is arranged to extend in the up-down direction of the vehicle. The upper and lower pipe has a spiral guide for guiding the liquid-phase working fluid so that the liquid-phase working fluid coming into contact with the inner wall of the upper and lower pipe flows down while rotating along the inner wall. Therefore, in the upper and lower pipe, the working fluid in the liquid phase descends as an annular flow. At the same time, the gas-phase working fluid rises inside of the annular flow (for example, at the center of the upper and lower pipe and in the vicinity thereof). Thereby, the gas-liquid separation of the working fluid is improved in the upper and lower pipe, and thus the cooling performance of the cooling device can be improved.

According to the sixteenth aspect, the upper and lower pipe includes the other condenser. The guide includes an internal fin that protrudes radially inward from the inner wall, and extends to the other condenser. Therefore, in addition to the function of guiding the working fluid in the liquid phase described above, it is possible to provide the guide with a function of facilitating heat exchange of the working fluid in the other condenser. As a result, it is possible to achieve both improvement in the performance of the cooling device and the simplification of the structure.

According to the seventeenth aspect, at least one of the evaporator, the other condenser, and the outdoor condenser has a flat tube portion configured as a part of the tubular member. The flat tube portion is arranged to extend and be inclined with respect to the horizontal direction of the vehicle at an angle close to the horizontal direction of the vehicle than the up-down direction of the vehicle is positioned more vertically than the vertical direction of the vehicle. The flat tube portion has a flat cross-sectional shape extending in the up-down direction of the vehicle. Accordingly, the gas-liquid separation of the working fluid in the flat tube portion is improved. For example, if the flat tube portion is the other condenser or the outdoor condenser, it is easy to increase the heat transfer area for transferring heat from the gas-phase working fluid in the flat tube portion to the heat radiation object. Thus, it is possible to obtain good condensation performance. If the flat tube portion is the evaporator, the heat transfer area for transferring heat from the target device to the liquid-phase working fluid in the evaporator can be easily increased, such that it is possible to obtain good cooling performance.

According to the eighteenth aspect, the predetermined heat radiation object is a refrigerant flowing in a predetermined heat absorbing portion of a refrigeration cycle circuit used in an air conditioning unit. The other condenser is arranged below the predetermined heat absorbing portion, and is fixed to conduct heat to the predetermined heat absorbing portion. Further, the predetermined heat absorbing portion forms a part of a refrigerant flow path in the refrigeration cycle circuit in which the refrigerant flows out of the expansion valve and is sucked into the compressor.

Therefore, since the liquid refrigerant and oil flow on the lower side in the predetermined heat absorbing portion in a biased manner, it is easy to radiate the heat of working fluid in the other condenser to the liquid refrigerant and oil. Further, in the other condenser, the gas-phase working fluid is more likely to be biased upward, e.g., toward the predetermined heat absorbing portion, than the liquid-phase working fluid is. For this reason, the condensing performance of the other condenser can be increased by preferentially using a part of the predetermined heat absorbing portion that easily absorbs heat.

According to the nineteenth aspect, the cooling device includes a second evaporator that forms a part of the sealed container in addition to the evaporator described above as the first evaporator. The second evaporator evaporates the working fluid by allowing the working fluid to absorb heat from a heating device that may become hotter than the target device by generating heat. Further, the second evaporator is disposed above the first evaporator and below a liquid level of the working fluid formed in the sealed container when the thermosiphon is not operated.

Therefore, in the second evaporator, the liquid-phase working fluid can easily absorb the heat of the heating device, and the working fluid can be favorably evaporated. Then, air bubbles generated in the second evaporator due to the heat of the heating device can flow out to the outdoor condenser instead of the first evaporator. That is, it is possible to restrict the bubbles generated by the heat of the heating device from radiating the heat to the target device.

What is claimed is:

1. A cooling device to be mounted on a vehicle and configured as a thermosiphon to perform heat transfer by a phase change between a liquid phase and a gas phase of a working fluid sealed in a sealed container to cool a target device by the heat transfer, the cooling device comprising:
an evaporator that forms a part of the sealed container and evaporates the working fluid by absorbing heat of the target device to the working fluid; and
an outdoor condenser that forms a part of the sealed container, the outdoor condenser being disposed above the evaporator, the outdoor condenser being located adjacent to a cabin space with respect to a vehicle body around the cabin space, the outdoor condenser being fixed to the vehicle body or a member provided adjacent to the cabin space with respect to the vehicle body, the outdoor condenser condensing the working fluid by radiating heat of the working fluid vaporized in the evaporator to an outside air, wherein
the outdoor condenser is fixed to the vehicle body,
the outdoor condenser is able to transmit heat to the outside air by being fixed to the vehicle body, and
the outdoor condenser is configured to allow the working fluid to radiate heat to another object different from the outside air.

2. The cooling device according to claim 1, further comprising:
an other condenser that forms a part of the sealed container and is arranged above the evaporator, the other condenser condensing the working fluid by releasing heat of the working fluid to a predetermined heat radiation object other than the outside air.

3. A cooling device to be mounted on a vehicle and configured as a thermosiphon to perform heat transfer by a phase change between a liquid phase and a gas phase of a working fluid sealed in a sealed container to cool a target device by the heat transfer, the cooling device comprising:
an evaporator that forms a part of the sealed container and evaporates the working fluid by absorbing heat of the target device to the working fluid; and
an outdoor condenser that forms a part of the sealed container, the outdoor condenser being disposed above the evaporator, the outdoor condenser being located adjacent to a cabin space with respect to a vehicle body around the cabin space, the outdoor condenser being fixed to the vehicle body or a member provided adjacent to the cabin space with respect to the vehicle body, the outdoor condenser condensing the working fluid by radiating heat of the working fluid vaporized in the evaporator to an outside air, wherein
the outdoor condenser is fixed to the vehicle body,
the outdoor condenser is able to transmit heat to the outside air by being fixed to the vehicle body, and
the cooling device further comprising: an other condenser that forms a part of the sealed container and is arranged above the evaporator, the other condenser condensing the working fluid by releasing heat of the working fluid to a predetermined heat radiation.

4. The cooling device according to claim 3, wherein
the sealed container has a tubular member, and
at least one of the evaporator, the other condenser, and the outdoor condenser is configured as a part of the tubular member.

5. The cooling device according to claim 3, wherein
the sealed container has a tubular member,
the other condenser is an indoor condenser that condenses the working fluid by radiating heat of the working fluid to inside air as the predetermined heat radiation object,
each of the evaporator, the other condenser, and the outdoor condenser is configured as a part of the tubular member, and the evaporator, the other condenser, and the outdoor condenser are arranged in this order from a lower side,
a lower end of the outdoor condenser is connected to an upper end of the other condenser, and
an upper end of the evaporator is connected to a lower end of the other condenser.

6. The cooling device according to claim 3, wherein
the predetermined heat radiation object is a refrigerant flowing in a predetermined heat absorbing portion of a refrigeration cycle circuit for an air conditioning unit,
the other condenser is disposed below the predetermined heat absorbing portion, and is fixed to conduct heat to the predetermined heat absorbing portion, and
the predetermined heat absorbing portion forms a part of a refrigerant path of the refrigeration cycle circuit in which the refrigerant flows out of an expansion valve to a compressor.

7. The cooling device according to claim 4, further comprising:
an upper and lower pipe configured as a part of the tubular member and arranged to extend in an up-down direction of the vehicle, wherein
the upper and lower pipe has a spiral guide configured to guide liquid-phase working fluid so that the liquid-phase working fluid in contact with an inner wall of the upper and lower pipe flows down while swirling along the inner wall.

8. The cooling device according to claim 7, wherein
the upper and lower pipe includes the other condenser, and
the guide is formed of an internal fin that protrudes radially inward from the inner wall, and is extended to the other condenser.

9. The cooling device according to claim 4, wherein
at least one of the evaporator, the other condenser, and the outdoor condenser has a flat tube portion configured as a part of the tubular member,
the flat tube portion is arranged to extend to be inclined with respect to a horizontal direction of the vehicle at an angle close to the horizontal direction than an up-down direction of the vehicle, and
the flat tube portion has a flat cross-sectional shape extending in the up-down direction of the vehicle.

10. The cooling device according to claim 3, wherein the evaporator is a first evaporator, further comprising: a second evaporator that forms a part of the sealed container, wherein
the second evaporator evaporates the working fluid by causing the working fluid to absorb heat from a heating device that is allowed to have a temperature higher than that of the target device, and
the second evaporator is disposed above the first evaporator and is located to be lower than a liquid level of the working fluid formed in the sealed container when the thermosiphon is not operated.

11. A cooling device to be mounted on a vehicle and configured as a thermosiphon to perform heat transfer by a phase change between a liquid phase and a gas phase of a working fluid sealed in a sealed container to cool a target device by the heat transfer, the cooling device comprising:
an evaporator that forms a part of the sealed container and evaporates the working fluid by absorbing heat of the target device to the working fluid; and
an outdoor condenser that forms a part of the sealed container, the outdoor condenser being disposed above the evaporator, the outdoor condenser being located adjacent to a cabin space with respect to a vehicle body around the cabin space, the outdoor condenser being fixed to the vehicle body or a member provided adjacent to the cabin space with respect to the vehicle body, the outdoor condenser condensing the working fluid by radiating heat of the working fluid vaporized in the evaporator to an outside air, wherein
the outdoor condenser is fixed to the vehicle body,
the outdoor condenser is able to transmit heat to the outside air by being fixed to the vehicle body,
the evaporator is a first evaporator,
the cooling device further comprising: a second evaporator that forms a part of the sealed container, wherein
the second evaporator evaporates the working fluid by causing the working fluid to absorb heat from a heating device that is allowed to have a temperature higher than that of the target device, and
the second evaporator is disposed above the first evaporator and is located to be lower than a liquid level of the working fluid formed in the sealed container when the thermosiphon is not operated.

12. The cooling device according to claim 3, wherein
the evaporator and the target device are disposed in the cabin space or in a space separated by a partition member to be opened to the cabin space, and
the outdoor condenser is fixed to the vehicle body so as to be detachable from the vehicle body.

13. The cooling device according to claim 3, further comprising:
an outdoor arrangement part that forms a part of the sealed container extended to outside of the cabin space through a through-hole defined in the vehicle body, the outdoor arrangement part being located outside of the cabin space, wherein
the evaporator and the target device are disposed in the cabin space or in a space separated by a partition member that is able to be opened to the cabin space,
the outdoor condenser is fixed to the vehicle body so as to be detachable from the vehicle body, and
the through-hole is formed in a size that allows the outdoor arrangement part to pass through the inside of the through-hole.

14. A cooling device to be mounted on a vehicle and configured as a thermosiphon to perform heat transfer by a phase change between a liquid phase and a gas phase of a working fluid sealed in a sealed container to cool a target device by the heat transfer, the cooling device comprising:
an evaporator that forms a part of the sealed container and evaporates the working fluid by absorbing heat of the target device to the working fluid; and
an outdoor condenser that forms a part of the sealed container, the outdoor condenser being disposed above the evaporator, the outdoor condenser being located adjacent to a cabin space with respect to a vehicle body around the cabin space, the outdoor condenser being fixed to the vehicle body or a member provided adjacent to the cabin space with respect to the vehicle body, the outdoor condenser condensing the working fluid by radiating heat of the working fluid vaporized in the evaporator to an outside air, wherein
the outdoor condenser is fixed to the vehicle body,
the outdoor condenser is able to transmit heat to the outside air by being fixed to the vehicle body,
the cooling device further comprising:
an outdoor arrangement part that forms a part of the sealed container extended to outside of the cabin space through a through-hole defined in the vehicle body, the outdoor arrangement part being located outside of the cabin space, wherein
the evaporator and the target device are disposed in the cabin space or in a space separated by a partition member that is able to be opened to the cabin space,
the outdoor condenser is fixed to the vehicle body so as to be detachable from the vehicle body, and
the through-hole is formed in a size that allows the outdoor arrangement part to pass through the inside of the through-hole.

15. The cooling device according to claim 3, wherein
the outdoor condenser radiates heat of the working fluid in the outdoor condenser to the outside air via the vehicle body, and
the outdoor condenser is fixed to a surface of the vehicle body adjacent to the cabin space to conduct heat to the vehicle body such that the outdoor condenser is able to transmit heat to the outside air.

16. The cooling device according to claim 15, wherein
the vehicle includes an outdoor condensing fin to facilitate heat transfer from the working fluid in the outdoor condenser to the outside air, and
the outdoor condensing fin is provided outside of the cabin space so as to be exposed to the outside air, and is fixed to conduct heat to the vehicle body.

17. The cooling device according to claim 15, further comprising:
a condensation heat diffusion plate joined to the outdoor condenser, wherein
the outdoor condenser is fixed to a surface of the vehicle body adjacent to the cabin space via the condensation heat diffusion plate.

18. The cooling device according to claim 3, further comprising:
an outdoor condensing fin provided outside of the cabin space so as to be exposed to the outside air, the outdoor condensing fin facilitating heat radiation from the working fluid in the outdoor condenser to the outside air, wherein
the vehicle body has a body through-hole passing through the vehicle body,
the outdoor condensing fin is fixed to the vehicle body to close the body through-hole from a side opposite to the cabin space, and
the outdoor condenser is fixed to a side of the outdoor condensing fin adjacent to the cabin space through inside of the body through-hole to conduct heat to the outdoor condensing fin.

19. The cooling device according to claim 3, further comprising:
a condensation heat diffusion plate joined to the outdoor condenser, the condensation heat diffusion plate having one surface; and
an outdoor condensing fin joined to the one surface of the condensation heat diffusion plate to facilitate heat radiation from the working fluid in the outdoor condenser to the outside air, wherein
the vehicle body has a body through-hole passing through the vehicle body, and
the condensation heat diffusion plate is fixed on the vehicle body to close the body through-hole from a side adjacent to the cabin space in a state where the outdoor condensing fin is exposed to outside of the cabin space through the body through-hole, such that the outdoor condenser is able to transfer heat to the outside air.

20. The cooling device according to claim 19, wherein
the one surface of the condensation heat diffusion plate has a fin peripheral portion located to surround a portion joined with the outdoor condensing fin, and
the fin peripheral portion is pressed against a body hole peripheral portion of the vehicle body that forms a periphery of the body through-hole, to seal a space between the body hole peripheral portion and the fin peripheral portion.
